(19) United States
(12) Patent Application Publication
(10) Pub. No.: US 2024/0328564 A1
(43) Pub. Date: Oct. 3, 2024

(54) Active Vacuum Insulation Panel

(71) Applicant: University of Alaska Fairbanks, Fairbanks, AK (US)

(72) Inventors: Tomas Marsik, Fairbanks, AK (US); Haley Nelson, Fairbanks, AK (US); Kaarle Strailey, Fairbanks, AK (US)

(21) Appl. No.: 18/502,927

(22) Filed: Nov. 6, 2023

Related U.S. Application Data
(60) Provisional application No. 63/422,724, filed on Nov. 4, 2022.

(51) Int. Cl. F16L 59/065

(52) U.S. Cl. CPC F16L 59/065

(57) ABSTRACT

An insulating element includes a shell having an interior and an exterior and a core material positioned within the interior of the shell. The core material is configured to inhibit collapse of the shell when the shell is subject to a pressure differential between the interior and the exterior. The shell defines an opening configured to provide communication with a vacuum source.

### CROSS-REFERENCE TO RELATED APPLICATION

This application claims priority to and the benefit of the filing date of U.S. Provisional Application No. 63/422,724, filed Nov. 4, 2022, the entirety of which is hereby incorporated by reference herein.

### GOVERNMENT SUPPORT STATEMENT

This invention was made with government support under N00014-19-1-2235 awarded by the Office of Naval Research. The government has certain rights in the invention.

### FIELD

This disclosure relates to insulation using at least a partial vacuum.

### BACKGROUND

Vacuum insulation can provide insulating values an order of magnitude higher than conventional insulation of the same thickness. While vacuum insulated panels (VIPs) have already started appearing on the market for building construction, they still face significant issues, some of them being that they are expensive, cannot be customized on-site, and lose vacuum over time.

### SUMMARY

Described herein, in various aspects, is an insulating element including a shell having an interior and an exterior and a core material positioned within the interior of the shell. The core material is configured to inhibit collapse of the shell when the shell is subject to a pressure differential between the interior and the exterior. The shell defines an opening configured to provide communication with a vacuum source.

Also disclosed herein is a system including an insulating element having a shell having an interior and an exterior; and a core material positioned within the interior of the shell. The core material is configured to inhibit collapse of the shell when the shell is subject to a pressure differential between the interior and the exterior. The shell defines an opening. The system further comprises a vacuum source in communication with the opening of the shell.

Additional advantages of the disclosed systems and methods will be set forth in part in the description that follows, and in part will be obvious from the description, or may be learned by practice of the claimed invention. The advantages of the disclosed systems and methods will be realized and attained by means of the elements and combinations particularly pointed out in the appended claims. It is to be understood that both the foregoing general description and the following detailed description are exemplary and explanatory only and are not restrictive of the invention, as claimed.

### DESCRIPTION OF THE DRAWINGS

These and other features of the preferred embodiments of the invention will become more apparent in the detailed description in which reference is made to the appended drawings wherein:

FIG. 1 (redrawn from R. Baetens et al. [1]) is a plot showing a theoretical Relationship Between Thermal Conductivity and Pressure of Air Contained Within Various Pore Sizes.

FIG. 2 (redrawn from R. Baetens et al. [1]) shows a theoretical Relationship Between Thermal Conductivity and Pressure of Common Core Insulation Materials.

FIG. 3 shows a relationship between various components in accordance with various collective terms used herein.

FIG. 4 shows a schematic exploded pump assembly.

FIG. 5 shows Table 2.1, illustrating properties of fiberglass used in prototype testing.

FIG. 6 shows Table 2.2, illustrating properties of barrier laminate used in prototype testing.

FIG. 7 is a schematic diagram showing a Sensor Arrangement for Passive Insulation Testing.

FIG. 8 is a schematic diagram of a sensor arrangement for active insulation testing.

FIG. 9 is a schematic diagram of a component arrangement of the system assembly.

FIG. 10 shows Table 3.1, illustrating a description of conditions and materials used for the EPS comparison test.

FIG. 11 shows Table 3.2, illustrating a description of conditions and materials used for the passive commercial VIP.

FIG. 12 shows Table 3.3, illustrating description of conditions and materials used for the Active Commercial VIP Test.

FIG. 13 shows Table 3.4, illustrating description of conditions and materials used for the Active Commercial VIP Test with Altered Barrier.

FIG. 14 shows Table 4.1, illustrating description of conditions and materials used for the Manufactured Active VIP.

FIG. 15 is a plot showing a relationship between the internal pressure and thermal conductivity of the manufactured active VIP.

FIG. 16 is a plot showing a comparison of the thermal conductivity vs. pressure relationships between theoretical values and test results.

FIG. 17 shows Table 5.1, illustrating a Summary of Testing Conditions and Results of Baseline and Prototype Testing.

FIG. 18 is a schematic diagram of an exemplary system comprising an insulating element as disclosed herein.

FIG. 19 shows a perspective view of an exemplary test apparatus as described herein.

FIG. 20 illustrates an exemplary environment for use of the insulating element.

### DETAILED DESCRIPTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout. It is to be understood that this invention is not limited to the particular methodology and protocols described, as such may vary. It is also to be understood that the terminology used herein is for the purpose of describing particular embodiments only, and is not intended to limit the scope of the present invention.

Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

It must be noted that as used herein and in the appended claims, the singular forms “a,” “an,” and “the” include plural references unless the context clearly dictates otherwise. Thus, for example, unless the context dictates otherwise, reference to “an inlet” provides disclosure of embodiments in which only a single such inlet is provided, as well as embodiments in which a plurality of such inlets are provided.

All technical and scientific terms used herein have the same meaning as commonly understood to one of ordinary skill in the art to which this invention belongs unless clearly indicated otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. Optionally, in some aspects, when values are approximated by use of the antecedent “about” it is contemplated that values within up to 15%, up to 10%, up to 5%, or up to 1% (above or below) of the particularly stated value can be included within the scope of those aspects. Similarly, in some optional aspects, when values are approximated by use of the terms “substantially” or “generally,” it is contemplated that values within up to 15%, up to 10%, up to 5%, or up to 1% (above or below) of the particular value can be included within the scope of those aspects. When used with respect to an identified property or circumstance, “substantially” or “generally” can refer to a degree of deviation that is sufficiently small so as to not measurably detract from the identified property or circumstance, and the exact degree of deviation allowable may in some cases depend on the specific context.

As used herein, the terms “optional” or “optionally” mean that the subsequently described event or circumstance may or may not occur, and that the description includes instances where said event or circumstance occurs and instances where it does not.

As used herein, the term “at least one of” is intended to be synonymous with “one or more of.” For example, “at least one of A, B and C” explicitly includes only A, only B, only C, and combinations of each.

As used herein “or” should be understood to be an inclusive or unless context dictates otherwise. For example, when separating items in a list, “or” should be interpreted as being inclusive, i.e., the inclusion of at least one, but also including more than one, of a number or list of elements, and, optionally, additional unlisted items. In other aspects, the term “or” can refer to only a single element of a list of elements.

It is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

The following description supplies specific details in order to provide a thorough understanding. Nevertheless, the skilled artisan would understand that the apparatus, system, and associated methods of using the apparatus can be implemented and used without employing these specific details. Indeed, the apparatus, system, and associated methods can be placed into practice by modifying the illustrated apparatus, system, and associated methods and can be used in conjunction with any other apparatus and techniques conventionally used in the industry.

Vacuum insulation panels, or VIPs, are among the highest performing forms of insulation available on the commercial market, with some per inch R-values being advertised as high as 60° F.·ft²·hr/(BTU·inch). Though there is strong market demand for high-performing forms of insulation, the adoption of VIPs is hindered by their relatively high costs, uncertain service lifespans, sensitivity to internal pressure changes, susceptibility to thermal bridging along their edges, and other issues. Particularly in building applications, typical VIPs are often passed over in favor of insulation types that can be easily customized on-site, produced to larger dimensions, and are not as vulnerable to damage or rough handling. Many of these challenges can be addressed by active VIPs. Active VIPs can be equipped with the means to be evacuated as often as is necessary to re-establish a desired internal pressure.

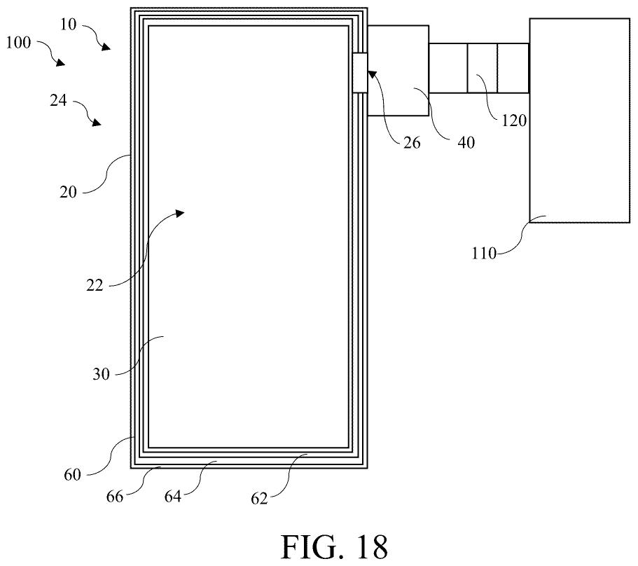

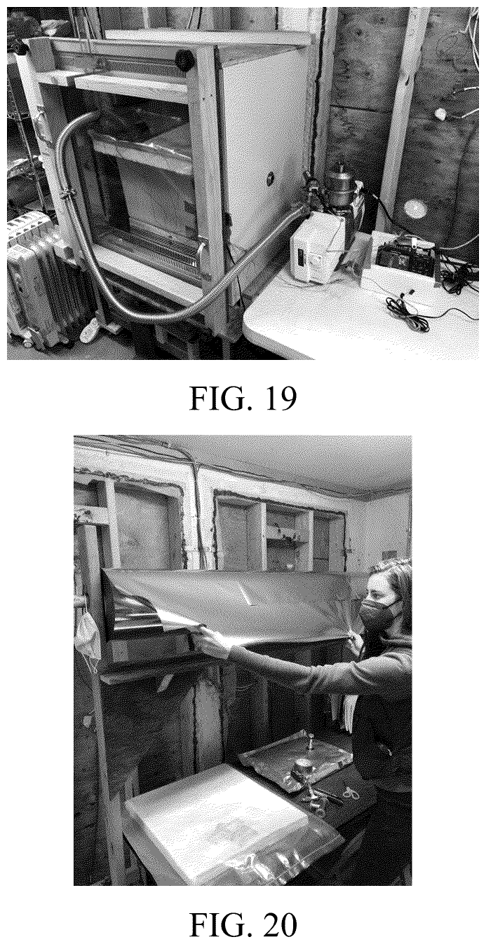

Referring to FIG. 18, an insulating element 10 is shown, the insulating element 10 comprising a shell 20 having an interior 22 and an exterior 24. A core material 30 is positioned within the interior 22 of the shell 20. The core material 30 can be configured to inhibit collapse of the shell when the shell is subject to a pressure differential between the interior and the exterior. For example, the core material can provide structural integrity to the shell 20. In some aspects, the core material 30 can compress by no more than 50% of its width when the insulating element 10 is subject to a vacuum (so that the pressure differential between the exterior and interior of the shell is about 1 atmosphere of pressure). In other aspects, the core material 30 can compress by no more than 40%, or 30%, or 20%, or 10% when the insulating element 10 is subject to a vacuum. In further aspects, the core material 30 can remain substantially uncompressed when the insulating element 10 is subject to a vacuum.

The shell 20 can define an opening 26 configured to provide communication with a vacuum source 110 (e.g., a vacuum pump or a vacuum tank including a sorbent). For example, the insulating element 10 can comprise a port 40 coupled to the shell 20 so that the port 40 is in communication with the opening 26 of the shell. The port 40 can be configured to fluidly couple to the vacuum source 110. For example, the port 40 can comprise a fitting for coupling to a pipe or hose. In some aspects, the fitting can be a national pipe thread (NPT)-style fitting. In other aspects, the fitting can be a QF-type fitting configured for vacuum pumps.

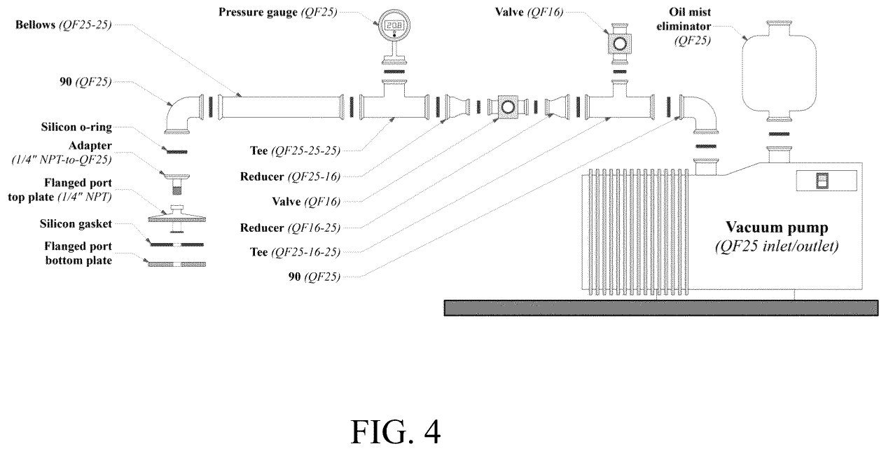

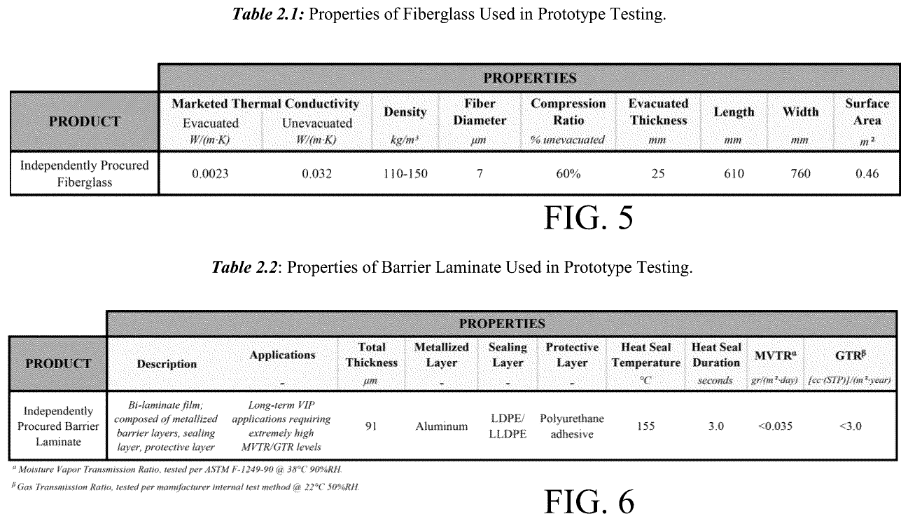

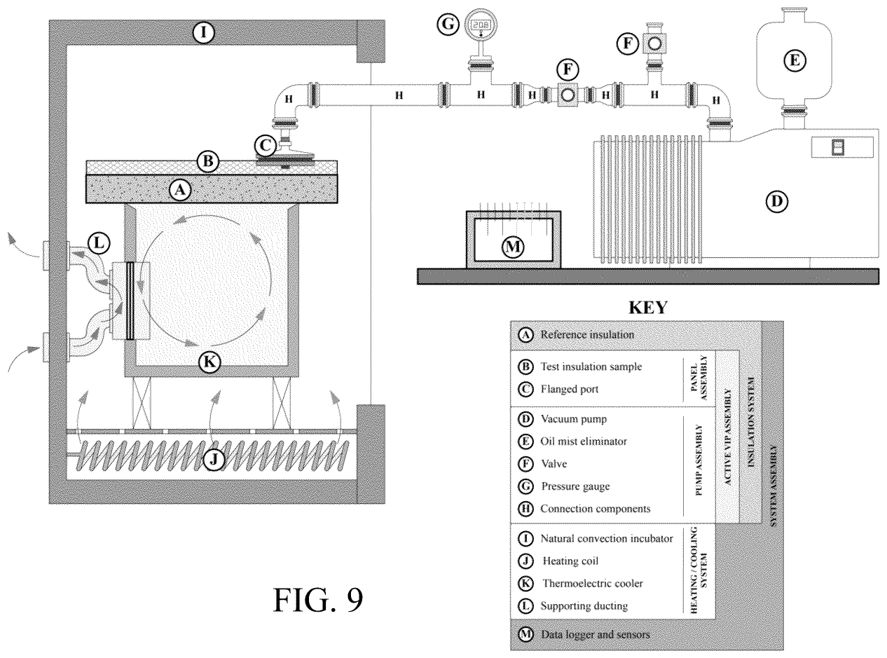

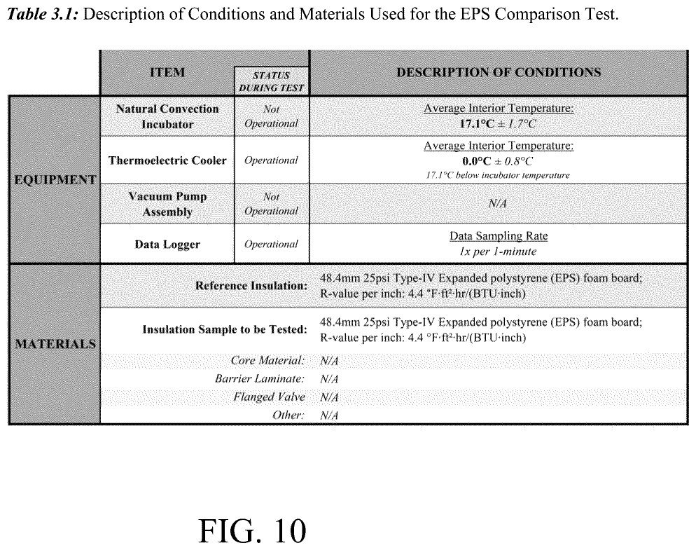

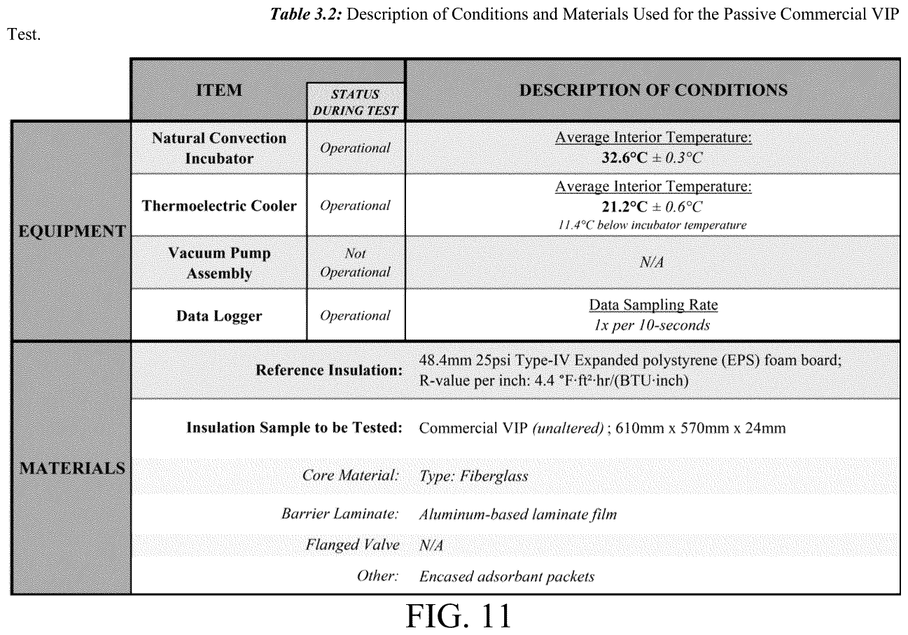

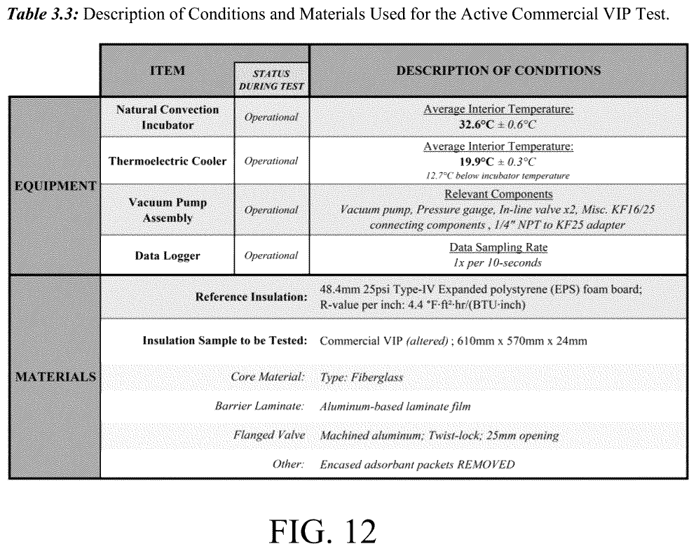

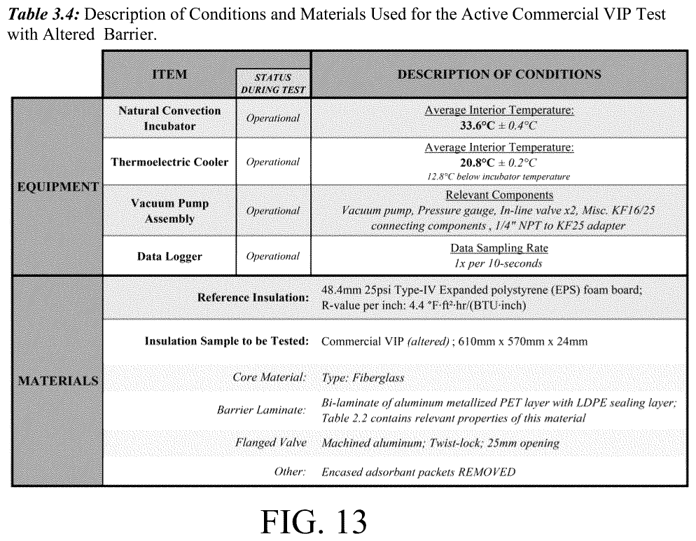

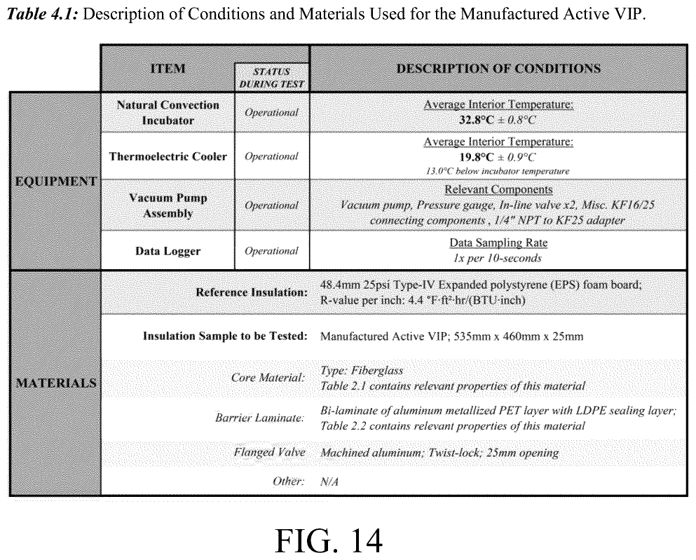

In various aspects, the port 40 can overlie the opening. In some aspects, the port 40 can be integrally formed with the shell (e.g., via heat sealing). In other aspects, the port can be coupled to the shell by a compression seal. For example, as illustrated in FIGS. 4 and 9, the compression seal can comprise an inner element received within the interior of the shell and an outer element positioned on the exterior of the shell and coupled to the inner element.

In some aspects, the core material 30 can comprise fiberglass, fumed silica, open-cell foam, aerogel, or nanogel. For example, the core material 30 can comprise, or consist of, or consist essentially of, fiberglass. In various aspects, the fiberglass can have a fiber diameter from about 1 micron to about 20 microns. For example, the fiberglass can have a fiber diameter from about 4 microns to about 10 microns, or about 7 microns. For example, the fiberglass can have a density from about 40 kg/m³ to about 300 kg/m³, or from about 110 kg/m³ to about 150 kg/m³. In some aspects, the fiberglass can have an unevacuated thermal conductivity from about 0.01 W/m/K to about 0.05 W/m/K. In some aspects, the fiberglass can have an evacuated thermal conductivity from about 0.001 W/m/K to about 0.005 W/m/K.

In some aspects, the shell 20 can comprise a laminate 60 (FIG. In various aspects, the laminate can include one or more of a sealing layer 62, a protective layer 64, or a barrier layer 66. For example, in some aspects, the laminate 60 can comprise each of a sealing layer 62, a protective layer 64, and a barrier layer 66. The layers of the laminate 60 can be arranged in any desirable order. For example, the laminate 60 can be arranged to include, from inside to outside, the sealing layer 62, the protective layer 64, and the barrier layer 66. In other aspects, the laminate 60 can be arranged to include, from inside to outside, the protective layer 64, the sealing layer 62, and the barrier layer 66; or the protective layer 64, the barrier layer 66, and the scaling layer 62; or the sealing layer 62, the barrier layer 66, and the protective layer 64; or the barrier layer 66, the sealing layer 62, and the protective layer 64; or the barrier layer 66, the protective layer 64, and the sealing layer 62. In some aspects, the laminate can include multiple sealing layers 62, multiple protective layers 64, and/or multiple barrier layers 66. Further, the laminate 60 can include further layers in addition to the sealing layer 62, the protective layer 64, and the barrier layer 66. In further aspects, the laminate 60 can exclude one or more of of the sealing layer 62, the protective layer 64, and the barrier layer 66. Optionally, the shell 20 can comprise a sealing layer 62, a protective layer 64, and a barrier layer 66, wherein one or more of the sealing layer 62, the protective layer 64, and the barrier layer 66 are provided as separate, non-laminated layers. In some aspects, the sealing layer can comprise polymer (e.g., optionally, low-density or high-density polyethylene (LDPE/HDPE)). The protective layer can comprise polymer (e.g., optionally, Polyethylene terephthalate (PET)). The protective layer can inhibit piercing of the shell 20. The barrier layer can inhibit moisture. In some aspects, the barrier layer can comprise a metal foil (e.g., aluminum foil). In some aspects, the barrier layer can comprise a metallized film. For example, an aluminum or metal oxide can be deposited on a substrate (e.g., a polymer substrate). In some aspects, the barrier layer can comprise a polymeric barrier. In some aspects, the laminate is heat-sealed along at least one edge to form the shell. For example, two rectangular sheets can be heat-sealed together along four edges to form the shell. In further aspects, a rectangular sheet can be folded upon itself and heat-sealed together along three sides.

Optionally, the insulating element 10 can comprise a getter or desiccant within the interior 22 of the shell 20.

In various aspects, the core material 30 can be configured to inhibit collapse of the shell 20 with a pressure differential between the interior 22 and the exterior 24 under 100 mTorr. Optionally, the core material can be configured to inhibit collapse of the shell with a pressure differential between the interior and the exterior under 10 mTorr.

In some aspects, the insulating element 10 can comprise an opacifier that is configured to inhibit radiative heat transfer.

In some aspects, the insulating element 10 or shell 20 can have a length of at least 500 mm and a width of at least 500 mm. In various aspects, the insulating element or shell 20 can be rectangular or generally rectangular. In some aspects, the insulating element 10 or shell 20 can have a thickness from about 0.5 cm to about 10 cm, or from 1 cm to about 5 cm. In some aspects, the insulating element 10 or shell 20 can be dimensioned for positioning within a wall of a building for insulation. In some aspects, the insulating element 10 or shell 20 can be dimensioned for use in forming a barrier of a refrigeration unit.

Optionally, a support structure can be configured to inhibit deformation of the insulation element 10 due to the pressure differential between the interior and the exterior. For example, a frame can be positioned against (optionally, coupled to) a surface of the shell 20 to inhibit deformation or collapse of the insulation element.

A system 100 can comprise an insulating element 10 and a vacuum source 110 (e.g., a vacuum pump) in communication with the opening of the shell 20.

In some aspects, the system 100 can further comprise a valve 120 that is configured to fluidly decouple the vacuum source 110 from the insulating element 10. Optionally, the valve 120 can be a check valve. In further aspects, the valve 120 can be a manually operated valve.

In some aspects, the vacuum source 110 can be configured to form a vacuum under 100 mTorr (optionally, under 10 mTorr). The vacuum source 110 can be, for example, a 2-stage vacuum pump.

In various aspects, a plurality of insulating elements 10 can be in communication with the vacuum source 110. A manifold can couple the vacuum source 110 to each of the plurality of insulating elements 10.

In various aspects, the vacuum source can be provide in several alternative use configurations. One alternative is that a vacuum pump is attached all the time and periodically engages to maintain the vacuum. Another one is that the vacuum pump is detachable. For example, the vacuum pump can be attached for the initial evacuation, then removed, and can then be attached at certain intervals (for example once a year) to bring the vacuum to a desired level. In some aspects, the interval can be predetermined. In other aspects, the interval can be determined based on a metric, such as a pressure rising above a threshold.

Another alternative is that the vacuum pump is only used for the initial evacuation and then a sorbent is used to maintain the vacuum. In some aspects, the sorbent can be centrally located. Passive Vacuum Insulated Panels (VIPs) can have a sorbent (typically referred to as dessicants and/or getters) embedded in the panel itself. However, in the active vacuum system 100 the sorbent can be accessible so that the sorbent can be replaceable and/or configured to be regenerated. For example, in an exemplary active vacuum insulation system, each of a plurality of active vacuum insulated panels (e.g., a plurality of insulating elements 10) can be connected to a common (e.g., central) location so each panel can be evacuated with a single vacuum source. At the common location, the vacuum source can comprise a vacuum tank with the sorbent therein to maintain the vacuum. When the sorbent becomes saturated (or filled enough that it no longer can maintain the required level of vacuum), the sorbent can be replaced or regenerated. (In this way, replacement or regeneration can be performed only after long terms (e.g., once in several years).

In various aspects, one of the forms of the insulating element can comprise a bag (potentially of very large dimensions, such as 6′×12′). The bag can comprise, for example, the barrier film. In further aspects, the bag can comprise a laminate (e.g., a sealing layer, a protective layer, and a barrier layer). Three sides of the bag can be sealed, leaving one side open. The bag can have a flange attached thereto. The flange can be connected to, or configured to connect to, a vacuum pump or other vacuum source. The core material (such as fiberglass) can be cut on-site to the desired dimensions and inserted into the bag and then the last seam of the bag can be made on-site (for example with a heat sealer) after the core material is inserted. The vacuum pump can be attached to the flange. Accordingly, the insulating element can comprise pre-made bags (with the flanges attached to them), core material (that the user is going to cut to size on-site), and vacuum components (hoses, vacuum pump, vacuum gauge, controller, and potentially valves). In these aspects, a kit can comprise all the materials that are needed to assemble the active vacuum insulation system on-site.

In various aspects, individual active vacuum insulated panels (e.g., insulating elements 10) can be directly linked to each other or each panel can be separately routed to the vacuum pump or a combination thereof. One such combination can be that two neighboring panels are linked to each other and each pair is then connected with one conduit (the term “conduit,” as used herein, is meant as a general term and can also include a hose, tubing, bellows, or combination thereof) to the vacuum pump. This configuration can reduce the number of hoses or other conduit elements going to the vacuum pump (or other vacuum source) while still allowing for the capability to isolate a relatively small portion of the vacuum insulation system if needed.

An active VIP prototype was developed and assessed in terms of the thermal performance. A system for testing active VIPs was first developed. The system for testing active VIPs testing capabilities was assessed. Following confirmation of the testing efficacy of the system for testing active VIPs, an active VIP prototype was constructed using independently procured metallized barrier laminate and fiberglass for use as the core insulation. The performance of the active VIP was profiled in terms of its thermal conductivity as a function of the internal pressure. The active VIP was found to have an R-value per inch of about 38° F.·ft²·hr/(BTU·inch) at internal pressures on the scale of 10⁰ mTorr. This R-value per inch is about an order of magnitude higher than conventional types of insulation used in building applications.

### Example 1

The following example provides a background on conventional VIPs as well as novel VIPs in accordance with the present disclosure. It should be understood that elements of conventional VIPs can be incorporated into the novel VIPs as disclosed herein.

### 1.1 Vacuum Insulation Panel Technology Overview

A vacuum insulation panel (VIP) is a type of panelized insulation product which exploits the insulative properties of evacuated space to provide extremely low thermal conductivities, translating to high per inch R-values. A passive VIP refers to panels which are evacuated once and rely on material composition of the panel to preserve the internal vacuum pressure within over its lifetime. Where most conventional insulations have associated R-values per inch in the range of 3-6° F.·ft²·hr/(BTU·inch), many commercially available (passive) VIPs advertise R-values per inch, measured at the center-of-panel, in the range of 50-60° F.·ft²·hr/(BTU·inch). These high insulation values at thinner thicknesses make VIPs an especially desirable choice in applications requiring high levels of energy efficiency and space savings.

### 1.1.1 Material Composition

Passive VIPs are composed of a core insulation material, an airtight barrier laminate membrane which forms an enclosure around the core insulation, and adsorbents such as getters and desiccants to accumulate gases and moisture over the life of the panel. Opacifiers may also be added to the core insulation to reduce radiative heat transfer. Once assembled, these materials are evacuated to low vacuum pressures and sealed.

### Core Insulation

Porous mediums comprising a solid matrix material with interconnected voids or pores are typically selected for use as core insulation in VIP applications. This is because the core insulation must serve two primary purposes: the first is to provide physical structure to panels to prevent their inward collapse under vacuum pressures, and the second is to provide a microporous matrix within which microporous vacuums are hosted [1]. Geometric properties of the porous medium, such as pore length, pore volume, spatial distribution of pores throughout the matrix, matrix shape, matrix orientation, and pore interconnection geometry contribute to the unique thermophysical properties of the core material and its resulting thermal conductivity. For micro-fibrous core materials typically used in VIP applications, pore diameters may range between 1-12 μm [2], where fiber diameters tend to be <10 μm [3]. For granular core materials such as fumed silica, pore diameters primarily range between 0.01-0.05 μm with some macropores ranging between 0.1-50 μm [4], while grain diameters range between 0.01-0.02 μm [4]). For open-cellular materials, pores and cell diameters fall under 100 μm [5], (100 nm [6]). though it is considered difficult to produce the more common foam core materials with cells smaller than 10 μm [5]. Generally speaking, core materials with smaller-diameter pores and fibers/granules offer better thermal performances [3] as do denser materials [7], owing to their superior performance at higher pressure ranges [8]. Densities between 100-300 kg/m³ are typical for most core materials [9].

A select set of core materials is used in most commercial VIPs available on the market today, including fiberglass, fumed silica, open-cell foams, and more experimentally, aerogels and nanogels. Typical thermal conductivities (in vacuum) associated with the most common VIP core insulation materials are 0.0022 W/(m·K) for fiberglass, 0.0036 W/(m·K) for silicas, and 0.0052 W/(m·K) for open-cell foams [10]. Many other powder, foam, and fiber-based core materials have been investigated for use in VIPs to optimize for cost, cradle-to-grave energy consumption and environmental footprint, ease of manufacturing, toxicity, and recyclability, but fiberglass- and fumed silica-based cores are used in a majority of commercially available VIPs. This is primarily due to the favorable thermophysical properties of fiberglass and fumed silica for a broad range of applications, as well as the advanced manufacturing infrastructure that has developed to support high-volume production of these materials.

The manufacturing of core materials is typically the most cost- and energy-intensive aspect of VIP production and is thus the main driver of cost for VIPs, with fumed silica-based VIPs being among the highest [11]. Though fiberglass cores are among the lowest-costing and require the least energy to produce [8], they still represent 60% of the total cost of fiberglass-based VIPs [10].

### Barrier Laminates

Barrier laminates are used to form protective envelopes which encase the core insulation, limit gas and moisture transmission through panels, and reduce heat transfer by radiation. To meet these requirements, barrier laminates used for most VIP applications include at least three distinct layers including a polymer-based sealing layer, a protective material layer to shield against punctures and abrasions, and a metallized layer or aluminum-based foil to mitigate gas and moisture transmission through the barrier.

The protective layer is often composed of a thicker polymer designed to handle surface stresses without yielding. Polyethylene terephthalate (PET) is usually chosen for this material, as it is relatively low-cost compared to other viable polymer types and offers some resistance to gas and moisture transmission [11]. The polymer-based sealing layer is usually a thermoplastic, often either low-density or high-density polyethylene (LDPE/HDPE). Applying high heat to two layers in contact creates an air- and water-tight seal. This layer is used in producing enclosed bags. Such thermoplastics may also be specifically selected for their low permeability to gas and moisture. Because the sealing layer is the most vulnerable to damage due to mechanical stresses over the life of the panel, high-strength and high-integrity thermoplastics are generally preferred to serve this role [11].

Barriers may fall into one of three categories based on their composition of layers. The first type is foil-based, where a continuous sheet of metal foil is heat-welded to enclose a core material. Foil-based barriers are usually made from aluminum, which is highly impermeable to gases and moisture [12], especially at greater thicknesses. Such films, owing to their tendency to be thicker and more durable, are highly resistant to mechanical puncturing and abrasions. However, the thicker metal layer of such films makes panels heavier and more susceptible to thermal bridging along their edges, which can dramatically impact the effective thermal conductivity of VIPs overall [13].

The second barrier type is polymeric-based. These films are composed of multiple polymer laminate layers for the various protective, barrier, and sealing functions. Assets of polymeric-based barriers are that they tend to be thinner, lighter, and experience less thermal bridging. Their deficits involve a higher prevalence of surface inhomogeneities and defects, higher vulnerability to surface damage, and higher permeability to gases and moisture [11]. These barriers are not intended for long service life applications, and generally must be paired with a getter [1].

The third barrier type is composed of metallized films. Like foils, these barriers are usually made using aluminum or other metallized oxides to exploit their low permeability, but in contrast to foils, the aluminum or metal oxides are applied in thinner layers onto a PET substrate [1]. The thinner layers lessen the magnitude of thermal bridging, while preserving the low permeability qualities to the extent possible. Metallized films also include a separate sealing layer. Proceeding discussions of this thesis will focus primarily on metallized film barriers, termed barrier laminates. In most cases, the thickness of a metallized barrier film will range between 30-100 nm per layer [6], while the total thickness of a barrier laminate composed of multiple metallized layers is typically around 100 μm [14]. Barrier laminates may also be thicker or thinner depending on desired performance requirements.

Because gas and moisture intrusion are the primary causes of degrading thermal conductivity of VIPs over time, the design and selection of barrier laminate becomes most critical for VIPs requiring long service lives. VIPs designed for use in long service life applications will often have multiple or thicker metallized layers, and consequently, very low gas and moisture transmission rates. As discussed, the trade-off for more metallized layers is higher thermal bridging along the edges of the panel, which impacts the overall thermal performance of the panel.

Barrier laminates marketed for VIP applications will provide the specific permeability of the laminate to gas and moisture, termed the Moisture Vapor Transmission Rate (MVTR) and Oxygen Transmission Rate (OTR), respectively. Also used is the Gas Transmission Rate (GTR) or Air Transmission Rate (ATR). GTR/ATR mainly measures nitrogen transmission and is considered a more appropriate measure of gaseous transmission. Typical to most VIP barrier laminates are MVTR properties in the range of <0.005 gr/m²·day, OTR properties in the range of <0.002 cm³/m²/24 hrs [11], and ideal GTR properties in the range of <25 cm³/m²/yr [15].

### Adsorbents

Adsorbents are commonly encased within passive VIPs to accumulate any intruding gases and/or moisture and thus preserve the thermal conductivity of the VIP over its lifetime. Getters and desiccants, which are responsible for accumulating gases and water/moisture respectively, will preserve the thermal conductivity within the VIP until they become saturated [9]. Adsorbents are generally selected for their compatibility with the core insulation, as well as their ability to complement permeability properties of the barrier laminate. For example, a barrier laminate with a higher permeability to oxygen, chosen to minimize thermal bridging along the panel edges, may be paired with a getter to accumulate intruding oxygen. Similarly, some core materials are more susceptible to gas and/or moisture accumulation than others.

### 1.1.2 Performance and Properties

### Heat Transfer Mitigation

Once evacuated, conduction through the solid matrix of the core material becomes the dominant mode of heat transfer [3]. Conduction also occurs through the barrier film, most notoriously along the edges of the panel. Along the panel edges, the metallized layers of the barrier laminate extend the full length of the heat transfer axis and create a highly conductive path typical for metal-based materials, causing linear transmittance. The magnitude of linear transmittance, also termed “thermal bridging,” depends principally on barrier thickness, barrier thermal conductivity, thickness of the core material, and core material thermal conductivity [16]. When factored in, the thermal bridging effect can increase the effective thermal conductivity of the entire panel by an order of magnitude [17]. This phenomenon is one of the challenges facing widespread integration of VIPs in building applications.

Though the primary principle of VIP technology is its virtual elimination of gaseous conductivity and convection within panels, VIP panels include features to address and limit all forms of heat transfer. While solid conductivity through the matrix of the core will always be present, its magnitude is limited due to the high void-to-solid ratio of the porous medium. Mitigating heat transfer by radiation is primarily dependent on the structure and opacity of the core material [18]. Opacifiers are often added to core materials to reduce the heat transfer by infrared radiation. Additionally, core materials with low emissivities and thus higher reflectance values are generally preferred for use in VIPs. Radiative heat transfer through VIPs may be reduced by up to two orders of magnitude compared to conductive heat transfer [18], but the tradeoff is often an increase in solid conductivity throughout the panel.

### Gas and Moisture Transmission

Of primary concern for most VIP applications is mitigating gas and moisture transmission through the barrier laminate, as their accumulating presence compromises the vacuum, and degrades the thermal conductivity of the panel over time. This is an especially critical concern for VIP applications requiring a long service life. Current research suggests that VIPs intended for long service life applications, and thus with extremely low-permeability barrier laminates, can expect annual pressure increases due to gas and moisture intrusion of approximately 750 mTorr per year [12]. Increased ambient vapor pressures, temperature, and air pressure can increase the rate of gas and moisture transmission through the panel, as these transmission rates are generally proportionate to the ratio of partial pressures within the panel and the ambient environment [12]. Therefore, the projected service life of a VIP can depend heavily on the environment in which it operates.

In addition to the intrusion of external gas and moisture, the accumulation of outgassed particulates originating from the core material and potentially the barrier film is also addressed in VIP design. Outgassing then becomes of critical consideration for core materials, which are sensitive to pressure increases due to gas and moisture accumulation. This sensitivity to pressure will be discussed further in the next section. In artificial aging tests of fibrous VIPs, outgassing was found to be responsible for an initial spike in VIP thermal conductivity during the first several weeks of operation [19]. This was followed by a slower rate of gas and moisture accumulation due to transmission through the barrier. Of the core materials typically used in VIP applications, polyurethane foams demonstrated the highest outgassing rates [14].

Due to the capillary condensation behavior of water at 20 nm scales and below, moisture vapor entering fumed silica-based panels saturates the pores and remains in liquid form [12], which negatively impacts thermal performance overall. This property renders fumed silica-based panels especially susceptible to moisture adsorption [20]. However, the tolerance of fumed silica to pressure increases due to moisture intrusion is much higher than compared to fiberglass [20].

### Thermal Conductivity and Pressure

The initial thermal conductivity of a VIP is dependent on the unique combination of materials used to construct it, as well as the pressure to which the panel is evacuated to [14]. While the choice of core material will define the theoretical limits of the initial panel thermal conductivity post-evacuation [8], it is the barrier laminate and associated adsorbents that will have the largest impact on panel thermal conductivity over its service life.

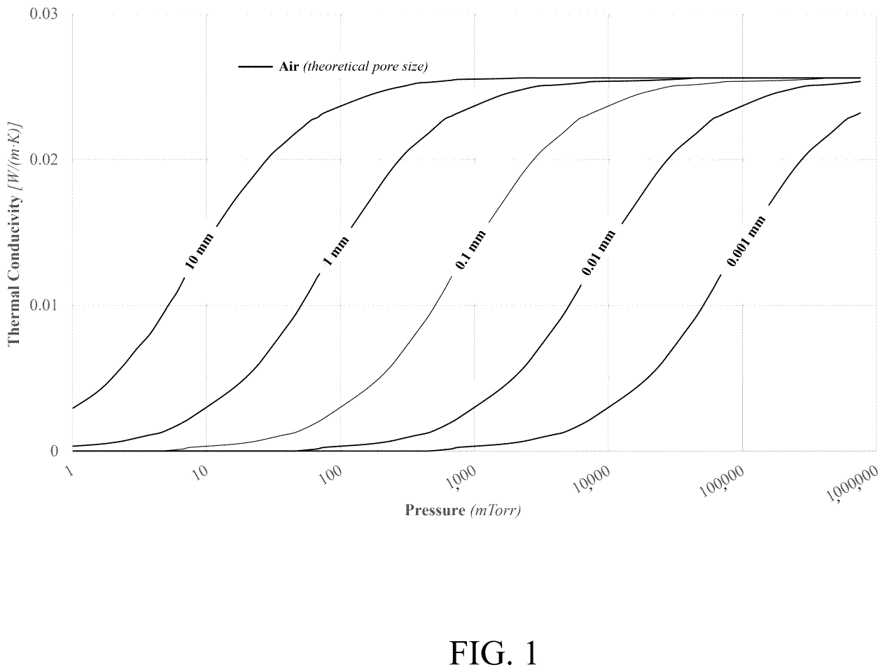

This relationship between thermal conductivity and pressure is largely dependent on coupled properties between the matrix and pores. FIG. 1 illustrates the theoretical relationship between thermal conductivity and pressure (note the logarithmic scale on the graph) for the case of air within pores of varying diameters contained within a theoretically massless matrix. This graph isolates the influence of pore size on the relationship between purely gaseous thermal conductivity and pressure. The primary takeaway from FIG. 1 is that materials with smaller pores do not require as much evacuation to reach low thermal conductivity values.

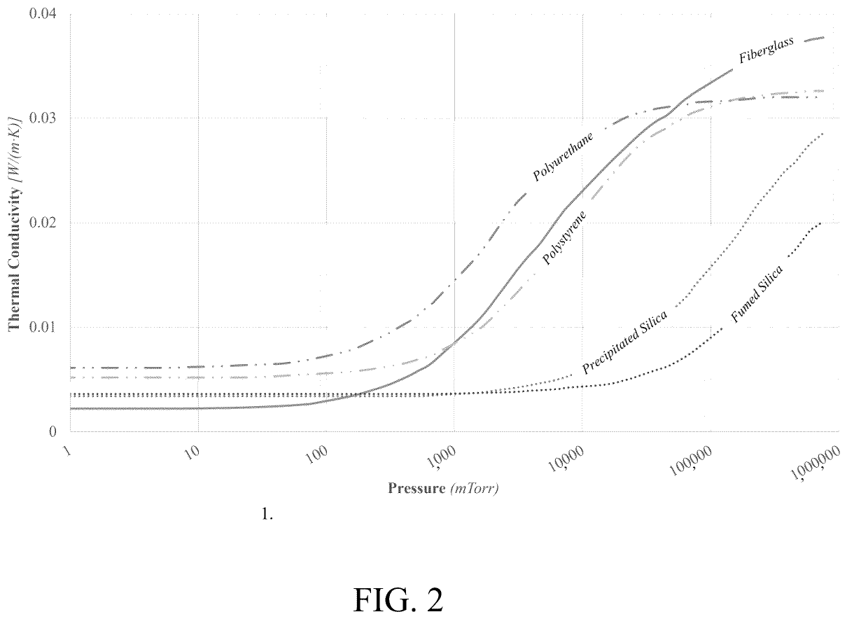

FIG. 2 illustrates this same theoretical relationship, but for core materials typically used in VIP applications. Here, the influence of the matrix structure and material manifest. As will become relevant in proceeding discussions, it is interesting to note two findings presented in FIG. 2. The first is that fiberglass theoretically offers the lowest thermal conductivity of any core insulation material when internal pressures are reduced below 10² mTorr, and the highest thermal conductivity at atmospheric pressures, giving it the widest range of thermal conductivities over the given pressure range. The second is that fumed silica reaches its lowest theoretical thermal conductivity at the highest-pressure relative to the other materials. This provides potential explanation as to why fumed silica panels are more prevalent than fiberglass panels on the commercial VIP market. Because vacuum pressures within VIPs degrade over time with gas and moisture intrusion, and because longer service life is desired in most VIP applications, fumed silica is selected more often for such applications, as it theoretically maintains lower thermal conductivities as pressures increase. Service life estimates provided by VIP manufacturers reflect this as well, where fumed silica VIPs advertise lifespans between 25-60 years, and fiberglass VIPs advertise a typical maximum of 15 years [8].

Important to note is that most commercially available passive VIPs market R-values per inch within the range of 35-72° F.·ft²·hr/(BTU·inch), which translates to a thermal conductivity range of 0.002-0.004 W/(m·K). Per the information presented in FIG. 2, for a fiberglass-based VIP to maintain a thermal conductivity close to its lowest value, its internal pressure must be kept below ˜10² mTorr. For a fumed silica-based VIP, the internal pressure must be kept below about 10⁴ mTorr.

### 1.1.3 Applications and Challenges

Commercially marketed VIP products are produced for three primary applications: refrigeration, cold chain logistics, and building industry. While some VIPs are produced for short-term applications, many commercially available VIP products advertise thermal performance service lives between 25-60 years [12]. VIP use in cold chain applications has grown, with an uptick during the COVID-19 pandemic, as worldwide VIP production shifted to meet the demands for insulated vaccine containers [21].

In refrigeration applications, interior space is usually at a premium, so thinner insulation products are desired. Additionally, insulation types with very low thermal conductivities are desired to keep operational costs low, even if the initial capital cost of such insulation is higher than more common alternatives. Still, VIPs used in most refrigeration applications favor lower-cost core materials such as fiberglass [22]. Because many refrigeration appliances have limited lifespans (approximately 10-15 years) based on other design factors [23], VIPs designed with longer projected service lives are not necessarily required but may be selected for their consistency of performance over time. Generally, the payback period for VIPs used in refrigeration applications (especially fiberglass-based VIPs) is the lowest of any application (between 3-10 years depending on its specific use [23]). Fragility of VIPs is less of a concern in refrigeration applications, as appliances are often designed such that VIPs are encased within a protective barrier, and are produced in factory conditions, as opposed to assembly in the field.

Cold chain logistics, like refrigeration technology, prioritizes space-saving and extremely low thermal conductivities in its insulation products, but for slightly different reasons. Cold chain logistics products are optimized around shipping constraints (weight, volume, etc.), and to passively preserve internal temperatures to the greatest extent possible, often for periods reaching 48 hours [24]. In general, this translates to low-weight, low-volume, low thermal conductivity material selections, for which VIPs are ideal. Fragility of VIPs is of slightly higher concern for cold chain logistics applications compared to refrigeration, as providing protective layers for VIPs may negatively impact total product weight, volume, and/or cost. Customizability of VIP shape and size is also desirable for certain cold chain applications.

Worldwide, buildings consume roughly 32% of global energy produced, and are responsible for 30% of global CO₂ emissions [25]. In the United States, this figure is closer to 40% [18], breaking down specifically to space heating and cooling demands. For this market, VIPs are poised to help reduce overall energy consumption considerably. Given their high R-value per inch, VIPs are an attractive choice in locations with many heating or cooling degree days, and/or when interior space is at a premium. VIPs produced for building applications typically have thicknesses between 20-40 mm and are designed with very long service lives. Fumed silica-based panels are often selected for use in building applications, as they generally outperform and outlast fiberglass-based panels in the environmental conditions common to building applications (humidity and temperature cycling, for example), but fiberglass VIPs are also present in the building industry.

Common challenges of VIP use in building applications include thermal bridging impacting thermal performance, the fragility of VIPs and their susceptibility to puncture during installation, inability to be customized, and higher cost compared to other common forms of building insulation [26]. Main challenges hindering deeper market penetration of VIPs include uncertainty in service life projections, high material costs, and the impact of thermal bridging [27]. Cost is considered a primary barrier to mass adoption of VIPs in building applications, as the payback period for VIPs is much longer than other forms of insulation. However, payback periods can be shortened through improvements to the overall thermal conductivity of the panel, either by addressing thermal bridging along the edges or the degradation of thermal performance over time.

Overall cost associated with VIPs is determined primarily by the cost of raw materials, including the core insulation and barrier laminate [12]. Production of fumed silica, the most common core insulation material used in VIPs for building applications, requires high manufacturing temperatures and multiple costly processing steps, rendering it among the most expensive core materials to produce [28]. Fiberglass core insulation is less expensive and less energy-intensive to produce, rendering it a lower-cost alternative VIP to fumed silica-based panels, but its shorter projected service life prevents it from being the most competitive option for most building applications.

Studies have also shown that the marketed center-of-panel thermal conductivities of VIPs for building applications may often be overestimations compared to the effective thermal conductivity of a VIP, which includes the non-negligible impact of thermal bridging [17]. Additionally, though VIPs for building applications are commonly advertised as having service lives exceeding 30 years, studies involving artificial aging tests suggest these advertised values are not always reliable estimates [12]. Annual thermal cycling, high humidity environments, and in-situ punctures can all lead to premature losses in internal vacuum pressures and consequent increases in thermal conductivity. Appendix B is a report written by the author investigating the performance of in-situ VIPs to determine if panel performance was degrading faster than its projected service life.

### 1.2 The Concept of Active Vacuum Insulation Panel

To help overcome the challenges associated with the use of the conventional passive VIP technology in building applications, the overarching goal of the research was to develop a prototype of what will herein be further referred to as an active VIP. It is a concept of a VIP that may be re-evacuated as often as desired to achieve desired lower pressures, and/or to remove accumulated moisture and gases. This requires the integration of an airtight port into the barrier membrane, which can then be connected to a vacuum source (e.g., a vacuum pump) for evacuation. Ideally, this port component provides a sufficiently wide passageway to support the rapid evacuation of any accumulated air and moisture within the panel, thus minimizing the operation time of the vacuum source.

The capacity of an active VIP to remove accumulated gases and moisture, lower pressures within the panel, and lower panel thermal conductivities as a result (see FIGS. 1-2) is what functionally differentiates an active VIP from a passive VIP. The inclusion of a primary component, an airtight port integrated into the barrier surface of the panel, is what mechanically differentiates an active VIP from a passive VIP.

Enabling a VIP to be re-evacuated when necessary provides the means to address the most common challenges facing VIPs, and the barriers to their deeper adoption within otherwise compatible markets. In particular, active VIP technology offers a solution to the degrading service life of VIPs due to gas and moisture intrusion, thereby preserving the thermal conductivity of a VIP indefinitely. VIPs that become punctured in-situ or experience other mechanical failures can potentially be patched, re-evacuated, and placed back into service, thus reducing the expense associated with retrofits or replacements.

Active VIP technology also potentially allows for lower thermal conductivities to be reached through the active evacuation of panels to deeper vacuum levels. Such a feature can not only help reduce operational costs associated with space heating and cooling, but also provides a means for actively modulating the thermal conductivity of an insulation system to a desired value. Especially in environments that experience a wide range of natural temperatures, an insulation product whose insulative value can be dynamically controlled can assist in further reducing space heating and cooling costs. In building applications and some refrigeration applications (such as for refrigerated semi-trucks), the energy supplied to an active VIP assembly for evacuating panels to a desired level may be considered a dispatchable load. In such applications, an active VIP assembly can theoretically become integrated into SMART building/refrigeration management systems for further reductions in energy consumption.

At present, the process of manufacturing passive VIPs typically requires specialized evacuation equipment. Evacuation of passive panels is usually conducted within evacuation chamber, which can not only be prohibitively expensive for smaller commercial operations or manufactured home industries to acquire, but also tend to limit the maximum dimensions a VIP can be produced to. The manufacturing of silica-based VIPs also requires specialized forming equipment, which poses similar limitations on customization. Additionally, once a passive VIP panel has been assembled, evacuated, and sealed, its dimensions cannot be changed without compromising the internal vacuum pressures.

By shifting the means of evacuation to a simplified vacuum pump and port assembly, customized active VIPs may be produced relatively inexpensively, and to maximum dimensions limited only by the constraints of raw material manufacturing. One of the primary advantages of maximizing the length and width of VIPs is that the ratio between the perimeter edges to the surface area reduces, thus mitigating the impact of thermal bridging on overall panel thermal conductivity. Though increased surface area generally results in a proportionate increase in water/moisture and gas transmission through the barrier laminate [12], this drawback is also rendered negligible when regular evacuation is factored in. Overall, by streamlining the manufacturing process of VIPs, reducing expense, and increasing customizability, active VIPs become a well-positioned candidate for expanded use in the general construction and refrigeration industries, with particular compatibility with the factory-built home industry.

Materially, active VIPs may be constructed from the same constituent materials as passive VIPs, except adsorbents, the need for which is eliminated once a panel can be re-evacuated regularly. For this same reason, active VIPs do not necessarily require barrier laminates that are extremely impermeable to gases and moisture, though higher-permeability barriers may be selected to reduce the frequency of evacuations. Though any core material with thermal properties like those presented in FIG. 2 may be suitable for use in active VIPs, fiberglass emerges as an especially attractive choice. This reasoning is twofold: 1) the thermal conductivity of fiberglass at low pressures (10⁰-10² mTorr) is the lowest among common VIP core insulation materials, which can theoretically be readily achieved in an active VIP system, and; 2) fiberglass is a lower cost material that does not require specialized equipment to customize, allowing fiberglass-based active VIPs to be produced to larger dimensions and/or shapes.

Some research and development efforts into active VIPs have been undertaken. An analytical model has been developed to examine the feasibility of active VIPs made from polyurethane cores. This model returned projected thermal conductivities between 0.005-0.029 W/m· K [29], which may be considered a non-viable result. Other studies have investigated various adaptive building insulation systems, including switchable insulation systems applied to residential roofs and a pressure-modulated fumed silica VIP [31]. Another study offered a comprehensive review of switchable insulation technologies [32]. Included in the discussion was an examination of “carrier density transition”-based technologies, which the active VIP system described previously may be classified as. This study concluded that the primary challenges facing active VIP systems controlled by vacuum pumps include long projected evacuation times, and consequently, potentially high energy demands. A final study offering a comprehensive review of VIP technology suggests that the ability to control and adjust the vacuum pressure within VIPs at will has energy-saving implications, but questions the overall economic viability of such a system [1].

In addition to these various studies, several patents have been filed. Among them is a self-healing barrier membrane [33], a thermostatically controlled, vacuum pump-modulated multi-panel system for soundproofing and insulating [34], and a twin-wall, vacuum pump-modulated system for use in furnaces, refrigerators, ovens, freezers, buildings, and acoustic walls [35].

However, none of these studies have specifically investigated the use of fiberglass core insulation, on-site manufacturability, or scalability, which by contrast are the focal points of this research. This research aimed to utilize proven concepts already developed and in use for passive VIP technology (as opposed to more experimental concepts, such as the honeycomb core structures offered by other active VIP researchers) while exploring necessary system modifications to overcome the common challenges facing VIP adoption in building applications.

### 1.3 Goals

This example aims to characterize a viable fiberglass-based active VIP assembly prototype and profile its performance in terms of its thermal conductivity as a function of the internal pressure. This effort requires:
Research into and procurement of appropriate core insulation and barrier laminate materials for use in active VIPs;
Development of effective, repeatable, and simplified manufacturing methods for active VIP panel assemblies;
Identification of appropriate, economical evacuation equipment for use in the active VIP assembly, and;
Identification and assembly of equipment for monitoring and testing the thermal performance of the active VIP assembly at various pressures.

A successful research outcome would be the production of a viable fiberglass-based active VIP assembly prototype, capable of providing thermal conductivities an order of magnitude better than conventional insulation. A validated prototype may then become eligible for further optimization research, testing, and experimentation into customizability, cost, ease of manufacture, operational energy consumption, and other yet to be determined priorities.

### 2.1 Introduction

### 2.1.1 Scope of Work

The purpose of this research was to develop, from commercially available products and materials, a prototypical active VIP assembly capable of attaining and maintaining vacuum pressures of 10⁰ mTorr within active VIP panels, and consequently achieving thermal conductivities comparable to passive VIPs also available on the commercial market. Excluded from research activities were:
Development of a full-scale prototype intended for building applications;
Thermal performance evaluations of active VIP systems under temperature and humidity conditions typical in building applications;
Activities to optimize the manufacturing process of an active VIP assembly; and
Activities to minimize the operational energy consumption of the system assembly.

### 2.1.2 Definitions

For clarity, the following terms will be used to describe specific sub-assemblies of the testing system described in this thesis.

Panel assembly refers to a prototypical assemblage of a barrier material, core insulation, and flanged port to form an active VIP.

Pump assembly refers to the assemblage of the vacuum pump and accessory components used to connect the pump to the panel assembly, and includes the vacuum pump itself, hoses or bellows, positional components such as elbows or tees, monitoring components such as pressure gauges, in-line valves, and any adapter fittings used to transition between fitting sizes or types.

Active VIP assembly refers to a system comprising the panel assembly and the pump assembly, connected together.

Insulation system refers to the assemblage of the reference insulation material and the active VIP assembly to form a unit of insulation.

Heating/cooling system refers to the system of appliances and associated accessories used to control the thermal environment in which the insulation system to be tested is placed. This system includes both cooling and heating appliances.

System assembly refers to the integrated assemblage of all materials and components to form a complete, operational system of equipment and materials that may be used for experimentation and testing.

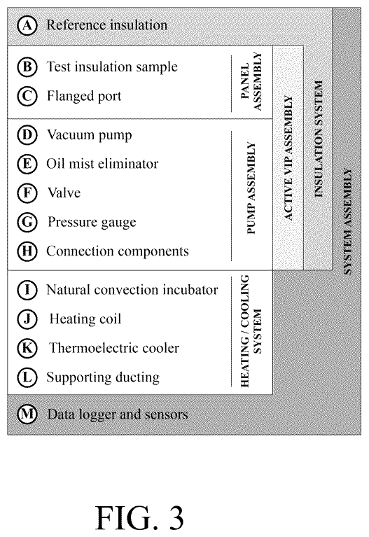

The key provided in FIG. 3 presents the relationship between various elements and sub-systems as described herein.

### 2.1.3 System Assembly Development Methodology

Previous work conducted by the author during the fall and winter of 2019 helped to direct the final selection of the equipment, materials, and methods used to develop the system assembly design discussed in this thesis report. During this period, multiple system iterations, including research equipment and materials to be tested, were evaluated to determine their efficacy in producing desirable research conditions.

### 2.2 System Assembly Requirements

To determine whether an active VIP panel assembly is performing as desired at low vacuum pressures, its thermal performance and internal pressure must be monitored. To effectively evaluate the thermal performance of prototypes, the system assembly used to test and monitor prototypes must be capable of the following:
Achieving and maintaining vacuum pressures on the scale of 10⁰ mTorr;
Maintaining a stable temperature differential across the insulation system;
Evacuating residual water vapor in a manner that does not compromise the health or integrity of the vacuum pump or other system assembly components; and
Determining the ratio of performance between an insulation sample of known thermal conductivity and the prototype.

The equipment, materials, and methods below were selected for their ability to generate and maintain these conditions. In the following discussion, critical items of equipment are discussed and grouped by the sub-assembly in which they appear, or for which they are used to construct. The materials described are those used in producing panel assemblies. Methods, both for manufacturing panel assemblies and for testing them, are described in the chronological order in which they were generally undertaken.

### 2.2.1 Equipment

### Pump Assembly

A Pfeiffer Vacuum 2021SD 2-stage rotary vacuum pump was used for the evacuation of panel assemblies. The 2021SD pump can evacuate closed systems at a rate of 22 m³/hr (12 cfm), attain vacuum pressures within a closed system on the scale of 10⁰ mTorr, and preserve the airtightness of an evacuated closed system when not in operation. The 2021SD pump is equipped with a gas ballast, which introduces controlled amounts of air into the compression chamber of the pump when condensable gases, such as water vapor, are being actively evacuated from a closed system. This prevents gas condensation from occurring within the pump during operation, which can damage the pump. Evacuations that require the use of the gas ballast are generally unable to attain vacuum pressures under 10¹ mTorr, and the vacuum pump is not considered airtight upon shutoff if the gas ballast is engaged.

The 2021SD pump is manufactured with 25 mm Quick Flange (QF25) type inlet and outlet fittings meeting the standards of the International Standards Organization (ISO). QF-type fittings include chamfered surfaces designed to accept a silicon O-ring gasket, and a metal centering ring which mechanically pressure-fits two QF fittings on either side of the O-ring gasket against each other through the tightening of a clamping screw. Such fittings are designated for use in deep vacuum applications.

An oil mist eliminator filter manufactured by the Kurt J. Lesker Company with QF25 fittings was connected to the pump outlet to assist with the reclamation of vaporized oil produced during operation. The inlet fitting is connected to a series of QF25 and QF16 components which connect the pump assembly to the flanged port of the panel assembly, allow for the real-time monitoring and collection of internal system pressures with an in-line pressure gauge, and control the rate of system re-pressurization through a system of in-line valves. FIG. 4 illustrates the pump assembly component arrangement.

A Kurt J. Lesker Company 275i module (Model #: KJLC275807) with a QF25 fitting was used as an in-line pressure gauge within the pump assembly. The KJLC275807 gauge displays the real-time pressure reading within a closed system in units of both Torr and millitorr depending on the magnitude of the pressure reading, with a measurement range of 10⁰-10⁶ mTorr.

Two Edwards Vacuum Speedivalves with QF16 and QF25 fittings (SP25K and SP16K respectively) were used as in-line valves within the pump assembly. Both valves are equipped with a control knob to manually open or close the valve.

### Heating/Cooling System

A Being Instruments BIT-200 natural convection incubator was used to create a stable temperature environment, within which the insulation system would be placed. The BIT-200 incubator can produce temperatures 5° C. warmer than external ambient temperatures at the coolest, and up to 80° C. The BIT-200 incubator is additionally able to maintain temperatures within ±0.2° C. of a desired setpoint. The internal dimensions of the incubator are 650 mm×600 mm×650 mm (W×L×H). Exterior dimensions of the incubator are 915 mm×658 mm×900 mm. The BIT-200 heating coil is installed under a perforated metal floor plate at the bottom of the incubator interior. Preliminary tests to determine whether a vertical temperature distribution existed within the incubator during operation revealed a maximum air temperature differential of ±1.4° C., with the warmest temperatures occurring nearest to the surface of the floor plate.

The BIT-200 was originally equipped with a windowless, insulated, and pressure-gasketed chamber door. Prior to prototype testing, the door was removed by the author and replaced with a lumber-framed plexiglass door, pressure-fitted to the perimeter gasket around the chamber using screwed bolts. This plexiglass alternative included an opening 30 mm in width to provide a passageway for pump assembly components to connect to the panel assembly placed within the incubator chamber. The plexiglass door also enabled the author to actively observe panel assemblies during tests.

Placed inside the BIT-200 incubator was a Koolatron 29 Quart thermoelectric cooler/warmer. For this research, the Koolatron thermoelectric appliance was used only as a cooler. The Koolatron cooler is rated to produce a stable temperature differential of 22° C. below ambient temperatures. Early testing with the appliance revealed that while it could produce a temperature differential of up to 22° C. when ambient temperatures were ˜10° C., it was frequently only capable of producing temperatures of 13° C.±1.6° C. below ambient when ambient temperatures exceeded 20° C. The internal dimensions of the cooler are 318 mm×310 mm×318 mm (W×D×H). Exterior dimensions of the cooler, excluding the lid, are 437 mm in width, 406 mmol in depth, and 350 mm in height. For use in the heating/cooling assembly, the lid originally included with the Koolatron cooler was removed to expose the cooled interior.

### Panel Assembly

A SealerSales KF-150CSTA Portable Direct clamping heat sealer with adjustable temperature settings was used to seal sheets of barrier laminate material along four sides to form VIP bag enclosures. The sealer heats to temperatures in the range of 140-200° C., which is a range compatible with the thermoplastic sealing layer of the barrier laminates used in this research. Seals produced by the KF-150CSTA heat sealer are 150 mm×15 mm.

### System Assembly

A Graphtec midi LOGGER GL220 data logger, equipped with ten analog voltage input terminals and USB/internal memory storage, was used to collect and store temperature and pressure data used to evaluate the thermal performance of the panel assembly at various vacuum pressures. The GL220 was programmed to collect and display data from each input terminal in five-second increments, and record data samples anywhere between one-second to 10-minute increments. Temperature data was collected and transferred to the GL220 data logger using five K-type thermocouples, each rated to measure temperatures within the range −100-1,370° C.

### 2.2.2 Materials

Prototypical active VIP panels manufactured for this research were comprised of a fiberglass core insulation material, a metallized barrier laminate formed and sealed such that it fully envelopes and encloses the core insulation, and a flanged port integrated into the surface of the barrier laminate to enable the connection of the panel assembly to the pump assembly. Unlike passive VIPs, active VIP prototypes did not include getters or desiccants, as the process of evacuation theoretically prevents the accumulation of moisture and gaseous vapors.

Chosen to serve as the reference insulation used in test insulation systems was Insulfoam R-Tech Type-IV 25 psi expanded polystyrene (EPS) foam board. Per manufacturer specifications, Type-IV EPS has a stable thermal conductivity of 0.033 W/m·K [R-value per inch of 4.4° F.·ft²·hr/(BTU·inch)] when evaluated at 24° C., per the ASTM C518 test method. Fiberglass specifically manufactured for use in VIP applications was selected as the core insulation material for prototypes. Table 2.1 outlines the properties of the independently procured fiberglass sample used in prototype testing.

Because active VIPs experience regular evacuation, the accumulation of gases and moisture can be addressed through evacuation as opposed to the optimization of laminate permeability. Thus, laminates procured for this research were not necessarily required to meet rigorous OTR and MVTR mitigation standards, and could therefore be thinner, potentially less expensive than barrier laminates manufactured for VIP applications, and cause less thermal bridging. Initial market research into economical, scalable barrier laminates revealed several varieties used in food preservation. However, many such laminates were either not mechanically strong enough to withstand low-force tearing, or else were much more permeable to gases and/or moisture. Considering these findings, metallized barrier laminates manufactured specifically for VIP applications were selected for use in prototype manufacturing. Table 2.2 outlines the properties of the independently procured barrier laminate sample used in prototype testing.

An Airtech VacValve 401 (VV401) machined aluminum port was used as the flanged port in prototypical panels. The VV401 port is composed of three discrete components, including a base plate, a connecting top plate with port fitting, and an intermediary silicon gasket. The VV401 port employs a mechanical twist-lock connection to fasten the base and top plates together against the barrier material. The top plate is manufactured to include a ¼″ male American National Standard Taper Pipe Thread (NPT) fitting for connection to the pump assembly.

### 2.2.3 General Methods

Manufacturing panel assemblies began with cutting a sample of both the fiberglass core insulation and EPS reference insulation to equal width and length dimensions. The width and length dimensions were chosen such that they extended sufficiently beyond the opening of the thermoelectric cooler to form an adequate lid, but not so large that they exceeded the interior dimensions of the incubator. The width and length dimensions chosen to meet these criteria were about 535 mm×460 mm. The thickness of the fiberglass supplied by the manufacturers varies, but all samples of fiberglass were altered such that they compress under evacuation to approximately 25 mm in thickness. The thickness of the EPS sample was fixed at 48.4 mm.

Following fiberglass and EPS preparation, two rectangular sheets of barrier laminate were cut to approximately 610 mm×760 mm. By cutting laminate sheets to dimensions larger than the fiberglass, volumetric deformations between the laminate layers caused by the fiberglass were minimized along the edges, and airtight seals were able to be applied more reliably. Edge seals were made by placing the two mirrored sheets of barrier laminate with their polyethylene surfaces in contact. These sheets were clamped between the upper and lower jaws of the heat sealer set to about 150° C. for approximately 3 seconds. Heat seals 150 mm in length were overlapped by 5-10 mm to form three of the four perimeter seals. Prior to sealing the fourth and final perimeter seal, the flanged port was installed in the barrier surface.

Installation of the VV401 port into panel assemblies included: 1) cutting and removing a 25 mm diameter circular section of the barrier material; 2) placing the base plate on the underside/inside face of the barrier material underneath the cut section; 3) applying a thin layer of low-volatility vacuum grease to the base plate and gasket faces to be in contact with the barrier laminate; 4) placing the gasketed top plate on the topside/exterior face of the barrier material, positioned and centered over the base plate, and; 5) locking the plates together to form an airtight seal against the barrier material. Teflon tape was applied to the ¼″ NPT thread of the port to reduce air leakage, and a ¼″ NPT-25QF adapter was fitted to the port to allow for its connection to the QF-type fittings of the pump assembly. After successful port installation, the fourth perimeter heat seal was applied to the barrier laminate to fully encase the fiberglass core insulation in the airtight enclosure.

Once completed, the panel assembly was positioned on top of the EPS reference insulation to form the complete insulation assembly. The thermoelectric cooler was positioned within the incubator interior, elevated slightly above the perforated floor plate to minimize direct conduction. Air, used by the thermoelectric cooler as the vehicle for heat transfer, was ducted in from outside the incubator to the thermoelectric cooling element and exhausted to the outside. The insulation assembly was then positioned on top of the cooler such that the bottom surface of the EPS faced the cooler interior, and the top surface of the panel assembly was fully exposed to the incubator interior.

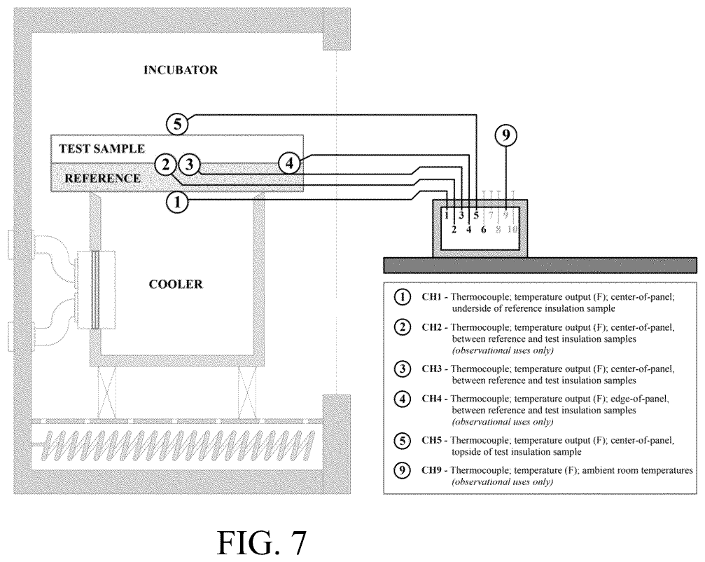

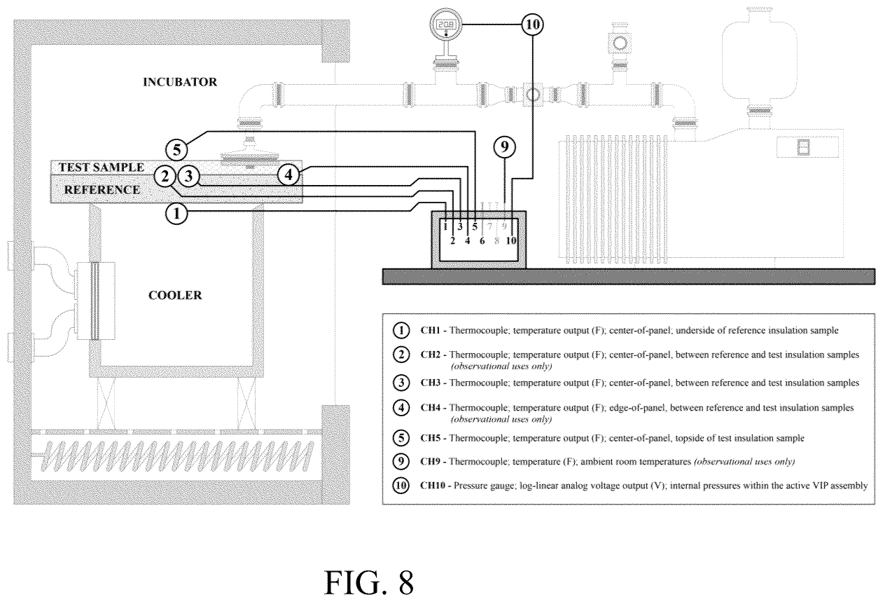

Five thermocouples were placed throughout the insulation system to register select temperatures. FIGS. 7-8 illustrate the placement of thermocouples when testing passive and active insulation samples, respectively. The CH1 thermocouple collected temperatures at the center-of-panel reference insulation surface exposed to the cooler environment. Two redundant thermocouples, CH2 and CH3, were placed between the reference insulation and the panel assembly, each placed within 10 mm of center-of-panel. The CH4 thermocouple was also placed between the reference insulation and panel assembly, but within 25 mm of the perimeter edge of the panel. Data collected from this sensor was used to observe the behavior of the panel edges, which are vulnerable to thermal bridging effects. The CH5 thermocouple collected temperatures at the center-of-panel surface exposed to the incubator environment. The CH9 thermocouple was placed outside of the incubator to monitor the ambient temperature of the room containing the system assembly. Data from the CH1, CH3, and CH5 thermocouples were used to calculate and analyze the relative thermal conductivity of panel assembly prototypes. The CH2, CH4, and CH9 thermocouples were used for observational and verification purposes only.

Once the thermocouples were installed, the perimeter edges of the insulation system were taped together to prevent air circulation between the reference insulation and panel assembly to minimize convective heat transfer at these sensors. Weights were placed upon the panel to assist the panel with compressing homogenously and flatly during evacuation, thus avoiding cupping or bowing. Upon final placement within the incubator the panel assembly was connected to the vacuum pump via a series of QF-type components, as illustrated in FIG. 9. Following the connection of the panel assembly to the pump assembly, the modified incubator door would be pressure-fitted against the incubator gasket, thus closing the incubator. At this stage, the system assembly was considered complete and ready for testing.

At the start of each new test, the vacuum pump would be run first with the gas ballast in the open position to remove any residual moisture from the fiberglass core insulation without damaging the pump. The gas ballast would remain open during evacuation until internal pressures dropped to approximately 10² mTorr, at which point the gas ballast would be closed. Evacuation would continue until the internal pressures on the scale of 10⁰ mTorr was reached. This pressure would be maintained for at least four hours to allow the temperature distribution across the insulation system to stabilize at the desired pressure.

Once sufficient data had been collected, analysis would proceed first by viewing a temperature and pressure time series for the entire testing period. Periods where the temperature and pressure were relatively stable would be isolated for further analysis. Temperatures from each thermocouple would be averaged over the stable period, as would pressure data (when present). From these values, the average temperature difference across the reference insulation and test sample would be calculated. The respective temperature differences would be divided by the thicknesses of each insulation sample, returning a relative temperature difference per unit thickness for comparison. This ratio between these values would be used to calculate the R-value per inch of the test sample, utilizing the known R-value per inch of the reference sample, as well as its thermal conductivity.

For select tests of active VIP assemblies, once an internal pressure on the scale of 10⁰ mTorr had been reached, the active VIP assembly would be allowed to incrementally repressurize until atmospheric pressure was reached. A logarithmic system of incrementation was used. Each desired pressure level was maintained for an extended period using a combination of the in-line valves and the vacuum pump. Once a stable pressure value had been attained, the temperature distribution across the active VIP system would be allowed to stabilize. Data used for analysis was from these stabilized periods. Re-pressurization and associated data collection continued incrementally until atmospheric pressure was reached.

### Chapter 3 Baseline Testing of System Assembly

### 3.1 Introduction

Before experimenting with panel assembly prototypes, it was necessary to ensure that the sub-assemblies of the system were operating as intended. This was to validate that the proposed methods were effective, and resulting data collected was of desired quality. Four baseline tests were designed to isolate and assess the performance of the critical equipment and methods, and confirm whether the system assembly was capable of creating and maintaining an environment suitable for testing active VIP prototypes. Results from these tests helped to gauge the compatibility between selected equipment, components, and the panel assembly, and allow the author to make optimization adjustments as necessary. Additional investigations into secondary system assembly characteristics were undertaken, summarized in Appendix A.

The first test evaluated a test sample of the same material and thickness as the reference sample (meaning two identical samples of insulation were stacked on top of each other). This was done to confirm that the presence of insulation would be correctly registered by the sensor arrangement and to validate that the thermal performances of these identical insulation samples were equal. The second test examined the performance of a passive VIP within the system assembly to first establish a passive VIP baseline for comparison against later active VIP tests, and secondly to determine whether any of the typical VIP characteristics conflicted with the system assembly. For the third test, a flanged port was installed within the same passive VIP (adsorbent packets removed) to convert it into an active VIP, and its thermal performance was monitored. This test was undertaken to validate that the components selected for use in active assemblies operated as intended. The final baseline test examined the performance of an active VIP constructed from the same fiberglass core of the passive VIP from previous tests, but with a different barrier laminate material. This test was to verify that the methodology developed for constructing panel assemblies produced viable results.

### 3.2 Baseline Test with Conventional Insulation

After the equipment described in Section 2.2.1 had been assembled, and prior to experimentation with VIP prototypes, a test was devised to validate the data collection methodology and identify any obvious issues with the system equipment. For this test, two identical samples of insulation, stacked on top of each other, were placed within the system assembly, and thermocouples were placed. The temperature distribution through the combined insulation system created from the two identical samples was monitored. This test was designed to identify any issues with the system assembly that would cause the thermal conductivity of identical samples to register as appreciably different. Potential anticipated issues included faulty thermocouples, an inhomogeneous thermal environment within the incubator, and/or problems related to how the insulation system was configured, among other potential issues.

### 3.2.1 Equipment, Materials, and Methods

For this test, the sample of EPS reference insulation was prepared and placed atop the thermoelectric cooler chamber and within the natural convection incubator, as outlined in Section 2.2.3. Though the incubator was used to house the insulation system during this test and provide some insulating value, it remained off during this test. A second identical sample of Type-IV EPS foam board to serve as the test sample was prepared and placed atop the reference insulation. Thermocouple sensors were placed in the arrangement illustrated in FIG. 7. After installation of thermocouples, the perimeter edges of the insulation samples were taped over to prevent air circulation between them. Neither of the samples were placed in an actively evacuated environment for testing, so the pump assembly was not included during this test and pressure data was not collected. Once in operation, stabilized temperature data was collected over a period of 30 hours.

Other equipment and materials selected for this test, and all relevant equipment settings, are summarized in Table 3.1. A more detailed description of the equipment and materials used can be found in Sections 2.2.1 and 2.2.2 respectively.

### 3.2.2 Results and Discussion

Analyzed data revealed that the thermal conductivity values of the two EPS samples, measured at the center-of-sample, were within 9.1% of one another on average over the testing period. Taking the R-value per inch of the bottom reference sample of EPS to be 4.4° F.·ft²·hr/(BTU·inch), the average R-value per inch of the top test sample of EPS was thus calculated to be 4.0° F.·ft²·hr/(BTU·inch). The discrepancy between samples is likely due to the R-value of the EPS foam board being somewhat temperature dependent. During this test, the bottom reference and top test samples of EPS were exposed to the approximate temperature ranges 0-9° C. and 9-18° C., respectively. According to properties published by the EPS manufacturer, samples operating in cooler temperatures (˜5° C.) will have higher R-values per inch than those operating in warmer temperatures (˜24° C.), but a quantifiable relationship between temperature and R-value was not offered. Though the exact R-values per inch thus could not be quantified, the difference in temperature range experienced by samples was considered sufficient to explain the R-value per inch disparity.

Given this explanation, the measurement error of the testing assembly is likely less than 9.1%, which is considered acceptable for the current stage of this research project. Therefore, no modifications were made to the arrangement of the heating/cooling system equipment, reference insulation, or sensors.

### 3.3 Baseline Test with a Passive VIP

Upon confirmation that the system assembly with conventional insulation performed approximately as intended, a second similar test was conducted with a passive VIP stacked on top of the EPS reference insulation. The primary goal of this test was to establish a baseline measure of thermal performance to compare subsequent active VIP assembly tests against. Secondarily, this test was designed to identify any issues or incompatibilities between the physical configuration of the system assembly and a VIP sample.

A commercially available passive VIP was procured for this test. This sample VIP, 24 mm in thickness, was composed of an aluminum-based laminate film, a fiberglass core, and adsorbent packets for gas and moisture. The thermal conductivity, baseline internal pressure, barrier permeability, and service life of this VIP were unknown. Additionally, though the sample VIP was tested two years after its initial procurement, an accurate estimate of its age is unknown.

### 3.3.1 Equipment, Materials, and Methods

For this test, the sample of EPS reference insulation was prepared and placed atop the thermoelectric cooler chamber, as outlined in Section 2.2.3. A passive VIP, sealed and unchanged from its original manufactured state, was placed atop the EPS reference insulation. Thermocouple sensors were placed in the arrangement illustrated in FIG. 7. After installation of thermocouples, the perimeter edges of the insulation samples were taped together to prevent air circulation between them, and weights were distributed atop the passive VIP to keep it pressed firmly against the reference insulation. Because the passive VIP would not be actively evacuated for testing, the pump assembly was not used during this test, and system pressure data was not collected. The actual internal vacuum pressure of the passive VIP was unknown. Once in operation, stabilized temperature data was collected over a period of 28 hours.

Other equipment and materials selected for this test, and all relevant equipment settings, are summarized in Table 3.2. A more detailed description of the equipment used can be found in Section 2.2.1.

### 3.3.2 Results and Discussion

Results from this test revealed an average R-value per inch of 18.1° F.·ft²·hr/(BTU·inch) for the passive VIP, compared to 4.4° F.·ft²·hr/(BTU·inch) of the EPS reference insulation. While its exact R-value per inch value cannot be confirmed, it does indicate that the passive VIP provides more insulative value than the EPS reference insulation, which would be expected. Due to the uncertainty in the age of the passive VIP and lacking a known R-value per inch for the sample, the data collected during this test was not used specifically to calibrate the system assembly. This test also confirmed that the passive VIP was not found to interfere with other components of the system, nor impact data collection process in any way.

### 3.4 Active VIP Assembly Validation

Following confirmation that the system assembly could accommodate a passive VIP, it was necessary to validate that the pump assembly performed effectively and compatibly with the rest of the system assembly components. To test this, a flanged port was installed within the barrier laminate of the passive VIP used in the previous test and connected to the pump assembly, now rendering it an active VIP. This test was expected to confirm that the lowest vacuum pressures reachable by the active VIP assembly were within a desired range. Also expected to be revealed were any issues with the configuration of system components that would prevent low pressures from being attainable or maintainable. Of secondary interest was whether the pump assembly configuration interfered physically or mechanically with any other sub-assemblies.

### 3.4.1 Equipment, Materials, and Methods

For this test, the passive VIP used to conduct the previous test covered in Section 3.3 was altered to include a flanged port within its barrier laminate. To install the port, the passive VIP was cut open along one of its four perimeter heat seals. Once opened, the encased adsorbent packets were removed, and a 25 mm hole was cut into the barrier laminate. The remaining steps to prepare the active VIP for testing are consistent with the process methodology described in Section 2.2.3. The final system assembly configuration is illustrated in FIG. 9, and the sensor arrangement is outlined by FIG. 8. Upon final assembly, the vacuum pump was turned on, and the active VIP system was allowed to evacuate until no further appreciable decreases in internal pressure were observable. At this pressure, evacuation would continue for at least four additional hours to allow for the temperature distribution across the insulation system to stabilize. Data collected during the stabilized period would be used for analysis.

Other equipment and materials selected for this test, and all relevant equipment settings, are summarized in Table 3.3. A more detailed description of the equipment used can be found in Section 2.2.1.

### 3.4.2 Results and Discussion

After approximately 16 hours of continuous evacuation, the active VIP assembly achieved a stable internal pressure of 4.63 mTorr. Once this pressure was reached, stabilized data was collected for an additional ten hours. At this pressure, the active VIP prototype registered an average R-value per inch of 49.6° F.·ft²·hr/(BTU·inch), the lowest R-value reached during the testing period.

These results show that the active VIP configuration was successful in attaining and maintaining conditions to support low thermal conductivities, consistent with the theoretical expectations shown in FIGS. 1-2. Specifically, this test confirmed that the flanged port and pump assembly were sufficiently airtight and capable of supporting internal system pressures on the scale of 10⁰ mTorr over the duration of the testing period, which was a critical condition for the system assembly to meet.

Of additional noteworthy interest is the increase in the R-value per inch of the active VIP compared to when it was tested in its passive state. The almost threefold increase in R-value per inch compared to the results of the passive VIP test suggests that the moisture and/or gas that had accumulated as the passive VIP aged were successfully evacuated, and their degrading impact on the R-value of the VIP mitigated. This is an especially validating result, given that this would be a critical function of a viable active VIP system assembly.

### 3.5 Barrier Laminate Alteration

Once the system assembly was confirmed to be usable for evaluating active VIPs, the remaining unknown variable to be tested was the efficacy of the separately procured barrier laminate film. For this test, the barrier laminate bag used in the previous tests was exchanged for a new bag constructed from the separately procured barrier laminate film of known properties. This new active VIP assembly was then subjected to otherwise identical test conditions described in Section 3.4.1. It was of interest to determine from this test whether the procured barrier laminate film could effectively produce airtight bags capable of achieving and maintaining internal pressures comparable to previous test results. Any issues resulting in an inability of the panel assembly to reach low internal pressures were to be identified and diagnosed.

### 3.5.1 Equipment, Materials, and Methods

Per the general bag-manufacturing methodology described in Section 2.2.3, a bag was hand-constructed from a new barrier laminate film of known properties. Relevant properties of this laminate are listed in Table 2.2. The fiberglass core insulation present from the previous two VIP tests was re-used and sealed within the new barrier laminate bag along with the flanged port. Once produced, this new active VIP assembly was subjected to test conditions identical to those described in the previous Section 3.4.1. The final system assembly configuration is illustrated in FIG. 9, and the sensor arrangement is shown in FIG. 8. Upon final assembly, the vacuum pump was turned on, and the active VIP system was allowed to evacuate until no further appreciable decreases in internal pressure were observable. At this pressure, evacuation would continue for at least four additional hours to allow for the temperature distribution across the insulation system to stabilize. Data collected during the stabilized period would be used for analysis.

Other equipment and materials selected for this test, and all relevant equipment settings, are summarized in Table 3.4. A more detailed description of the equipment used can be found in Section 2.2.1.

### 3.5.2 Results and Discussion

After approximately 14 hours of continuous evacuation, the active VIP assembly achieved an internal pressure of 5.19 mTorr, which is within the same order of magnitude of the lowest pressure reached during the previous test. Once this pressure was reached, stabilized data was collected for an additional ten hours. At this pressure, the active VIP prototype registered its highest average R-value per inch of 47.4° F.·ft²·hr/(BTU·inch). This is within 4.0% of the R-value result of the previous test. The achieved pressure and R-value per inch indicate that there does not exist an appreciable difference between the barrier laminates used to encase the panel assemblies of each test.

These results, and their consistency with the results from the previous test, validate that the specific barrier laminate procured to produce test prototypes was of sufficient quality and did not exhibit any issues that would suggest it was not fit for use in active VIP applications.

### 4.1 Introduction

Upon successful completion of baseline testing and validation that the system assembly functioned as intended, a new active VIP assembly prototype was constructed from materials of known properties and tested within the system assembly. This test was to verify that a viable active VIP prototype could be produced from commercially available, separately procured versions of the barrier laminate and fiberglass core insulation. A different selection of the fiberglass core insulation for this test is what differentiates it from all previous baseline tests. Successful prototypes would then become eligible for advanced optimization activities and testing. Such activities may include scaling up prototypes for building applications, improving the airtightness of the flanged port and pump assembly, exploring more economical approaches to manufacturing active VIPs, and determining the projected operational energy consumption of the system assembly as a whole.

### 4.2 Final Active VIP Prototype

### 4.2.1 Equipment, Materials, and Methods

Critical for this test was the use of commercially available materials in the panel assembly.

Relevant properties of the fiberglass core insulation and barrier laminate chosen for this test are listed in Tables 2.1 and 2.2, respectively. From these materials, an active VIP assembly was produced using the complete general methodology described in Section 2.2.3. Once produced, this new active VIP assembly was subjected to test conditions identical to those described in the previous Section 3.5.1. The final system assembly configuration is illustrated in FIG. 9, and the sensor arrangement is shown in FIG. 8. Upon final assembly, the vacuum pump was turned on, and the active VIP system was allowed to evacuate until no further appreciable decreases in internal pressure were observable. At this pressure, evacuation would continue for at least four additional hours to allow for the temperature distribution across the insulation system to stabilize. Data collected during the stabilized period would be used for analysis. Following data collection during the stabilized period, the active VIP system was incrementally repressurized in the manner described in Section 2.2.3.

Other equipment and materials selected for this test, and all relevant equipment settings, are summarized in Table 4.1. A more detailed description of the equipment and materials used can be found in Sections 2.2.1 and 2.2.2 respectively.

### 4.2.2 Results and Discussion

After approximately 30 hours of continuous evacuation, the active VIP assembly achieved an internal pressure of 5.87 mTorr, which is within the same order of magnitude of the lowest pressure reached during the previous active VIP test. Once this pressure was reached, stabilized data was collected for an additional 18 hours. At this pressure, the active VIP prototype registered its highest average R-value per inch of 37.6° F.·ft²·hr/(BTU·inch). The R-value per inch resulting from this test is approximately 21% less than the previous active VIP tests, indicating that the change in fiberglass core material is likely responsible for the lower R-value per inch.

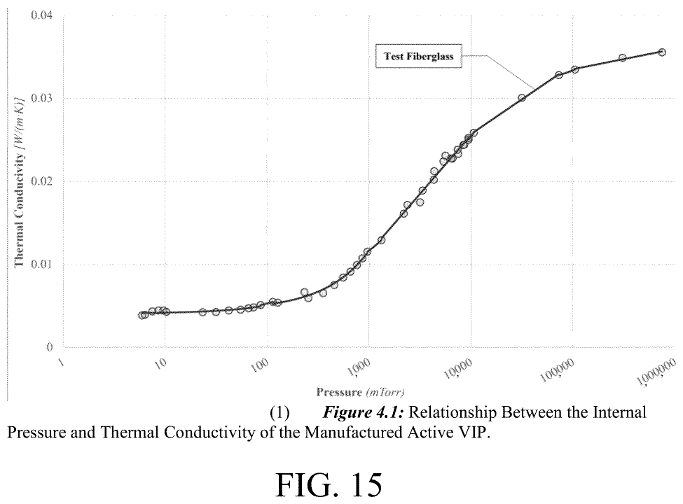

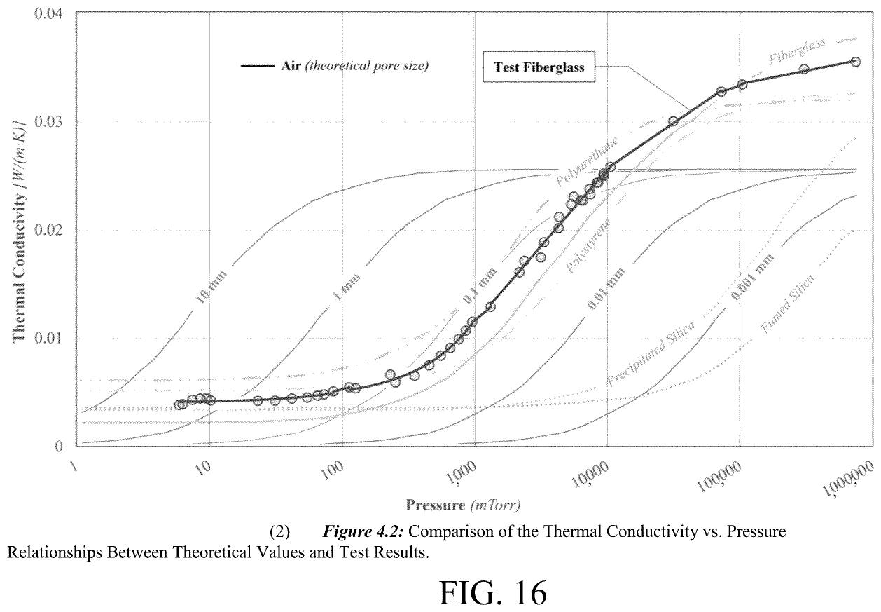

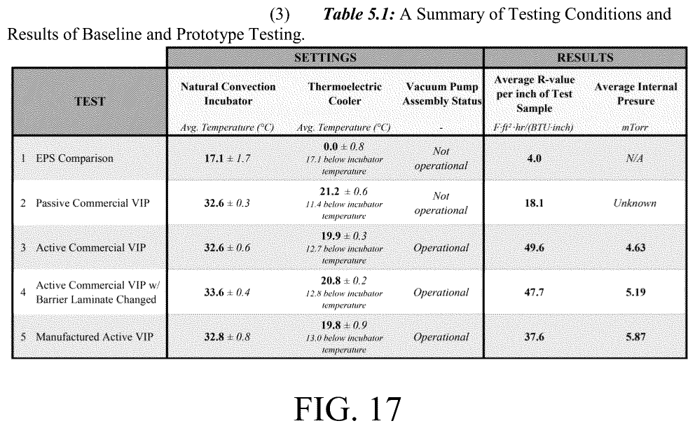

The results of the re-pressurization process, which are illustrated in FIG. 15. As seen in FIG. 15, the thermal conductivity of this active VIP assembly remained consistent as pressure increased until the internal pressure reached about 50 mTorr. At this pressure, the thermal conductivity began increasing at a higher rate. The rate of increase in thermal conductivity began to taper as pressures reached 10⁴ mTorr but did not plateau to an upper limit as the system reached atmospheric pressure (7.6×10⁶ mTorr).

The data collected during the controlled re-pressurization process revealed a positive correlation between pressure and thermal conductivity that was consistent with the theoretical relationship detailed in FIGS. 1-2. A comparison between the theoretical expectations detailed in FIGS. 1-2, and the results of this test are superimposed together in FIG. 15. It may be noted that the fiberglass used in this test exhibited thermal conductivity properties highly similar to that of the theoretical fiberglass through the pressure range 10⁰-10⁴ mTorr. The primary difference within this range is that the test fiberglass exhibits a shift in thermal conductivity of approximately +1.6×10⁻³ W/m·K [R-value per inch of 28.0° F.·ft²·hr/(BTU·inch)]. This is likely due to differences in pore size and/or fiber diameter between the test fiberglass and the theoretical fiberglass, as it is the coupled relationship between these two properties that dictates thermal conductivity under these conditions.

Also, of note is that the test fiberglass exhibits lower thermal conductivities than that of both polyurethane and polystyrene foams consistent with theoretical expectations, but higher than that of the fumed and precipitated silicas when it should theoretically be lower. As discussed above, the unique properties of the test fiberglass, namely its pore size and fiber diameter, are likely responsible for the higher thermal conductivities.

Overall, results of this active VIP test validated the following criteria:
The system assembly, as designed, can achieve internal panel pressures on the scale of 10⁰ mTorr; and
At pressures below 10² mTorr, the active VIP prototype achieved thermal conductivities an order of magnitude greater than typical insulation materials used in building applications.

### Chapter 5 Conclusions and Recommendations

### 5.1 Conclusions

Baseline testing of the system assembly, described in Chapter 3, showed that the developed methodologies and the selected arrangement of equipment and materials were satisfactory in their capacity to produce and maintain adequate testing conditions. Specifically, the active VIP assembly system was capable of reliably evacuating panel assemblies to pressures on the scale of 10⁰ mTorr, and the heating/cooling system maintained a sufficiently stable temperature differential across the insulation system over the course of testing periods. Results of the baseline tests confirmed that the equipment, materials, and methodologies described in this thesis are effective and repeatable for assessing the thermal performance of active VIP prototypes. Table 5.1 summarizes the key testing conditions of each test and the resulting calculated R-value per inch values for each test insulation sample.

Furthermore, baseline tests revealed that the conversion of a passive VIP into an active VIP assembly improved its thermal performance. This supports the conclusion that the prototypical active VIP assembly was successful in re-evacuating panels to lower vacuum pressures than were supported by its passive state, and which may or may not have been compromised from gas and moisture intrusion. This finding has positive implications regarding the capacity of active VIP assemblies to improve upon the thermal performance of passive VIPs and extend service life projections through regular evacuations.

Results from testing the active fiberglass VIP prototype, described in Chapter 4, revealed a maximum R-value per inch of 37.6° F.·ft²·hr/(BTU·inch). While this result is less than what was theoretically expected for fiberglass, its relationship in terms of increases in thermal conductivity with increasing pressure was found to be consistent with theoretical expectations. The lower maximum R-value per inch may likely be explained by the unique physical properties of the fiberglass matrix, as well as the particular orientation of its fibers, but determining these properties was not within the scope of these research activities.

From this research, the theoretical performance expectations were validated for the active VIP assembly prototype. Additionally, it was confirmed that a successful prototype could be developed at relatively low cost, manufactured using relatively non-specialized equipment, and to customized dimensions. From these findings, such a prototypical active VIP assembly may be considered a viable candidate for further research and development, ideas for which are described in the next section.

### 5.2 Recommendations

As climate change continues to intensify, so does the need for adaptable technologies capable of mitigating worldwide energy consumption. While passive VIPs have long been identified as a key technology in creating more energy-efficient options, their mass adoption is hampered by several key challenges. Active VIP technology is well-positioned to address many of the primary challenges facing the adoption of passive VIPs. It is the hope of the author that through further system optimizations, active VIP technology may yet emerge as a key contributor to making building and refrigeration systems more energy efficient.

The following aspects are consistent with embodiments of the present disclosure: 1) optimizing the equipment, materials, and/or manufacturing methodology used to produce active VIP assemblies; 2) developing application-specific active VIP assembly prototypes, and; 3) optimizing system costs, initial and operational energy consumption, environmental footprint/lifecycle analyses, and ease of manufacturing. Based on observations made during this research, improvements on the scale of the panel itself may offer the lowest-hanging fruit in improving the performance of active VIP assemblies. The following recommendations focus primarily on panel-scale system improvements:

The flanged port component stands out as a weak link regarding the long-term maintenance of internal vacuum pressures. Improvements to the port technology may have considerable impact on the ability of panel assemblies to maintain vacuum pressures for extended periods of time. Specific improvements might include heat-sealing a port component directly into the barrier laminate membrane, eliminating NPT/SAE connection fittings in favor of QF fittings, and incorporating a highly air- and pressure-tight, manually controlled valve to enable the regular disconnection of the pump assembly from the panel assembly.

Future testing systems should investigate and incorporate high-precision equipment for detecting and locating gas and moisture infiltration into the panel. Such equipment would help with identifying the weak links in the system and allow for more precise adjustments to component selections and configurations.

The extent of thermal bridging in active VIP assemblies should be quantified, and the resulting effective thermal conductivity of prototype assemblies calculated.

Automation, both of the pump and for valves involved in closing the panel system, will likely be a part of active VIP assemblies used in commercial applications. Market research into automation strategies and equipment, and experimentation with viable options will improve the overall energy efficiency and operational costs of active VIP assemblies.

For use in building and some refrigeration applications, active VIPs may benefit from being manufactured to much larger dimensions, on the scale of wall assemblies. Testing of such larger-scale prototypes may reveal the evacuation behavior of larger panels and/or the difficulty or ease of achieving and maintaining vacuum pressures on the scale of 10⁰ mTorr and associated thermal conductivity levels. Scaling up further and experimenting with multiple wall-scale panels connected to a pump assembly manifold would provide valuable information regarding the feasibility of more complex system assemblies.

Key challenges regarding the manufacture of larger panel assemblies also would be critical to explore. This would include a considerable amount of market research to identify the key constraints preventing larger-scale panel manufacturing and extensive experimentation into the process of constructing larger-scale panels. Specifically exploring manufacturing methods that are compatible with factory-built home applications may move this technology further towards potential adoption by the industry.

Continuing to develop manufacturing processes of active VIP assemblies to the point where they are streamlined, limit the need for specialized equipment, and can be performed in less-than-precise conditions would assist in broadening the application scope of active VIP technology.

A comprehensive analysis of the operational energy consumption of mature active VIP systems will need to be performed. As has been highlighted by several studies [1], [30]-[32], the viability of active VIP systems will depend on whether they can save more energy than they consume in operation. Refinements to the design and composition of the system to prioritize shorter run-times of the vacuum pump, reduced air infiltration through various system components, and other strategies to preserve internal pressures for as long as possible will be critical.

Similarly, a comprehensive economic analysis of the system will be necessary to identify areas to improve system costs (both initial and operational). Lowering associated costs where possible will help active VIP systems achieve deeper market penetrations.

Experimentations with alternative core materials and barrier laminate compositions may help identify combinations compatible with specific applications. Such investigations may also be able to identify materials which are more affordable, locally available, with favorable thermophysical properties at low pressures, stable, environmentally friendly, and less sensitive and/or permeable to gas and moisture transmission.

### Preliminary Active VIP System Iterations and Lessons

At the onset of preliminary research and testing of active vacuum insulation panel system assemblies, available equipment included:
YellowJacket SuperEvac 8 CFM 2-stage rotary vane vacuum pump, Model #93580, designed for use in priming refrigeration and air conditioning appliances;
Vacuum pump assembly components (various brands), including hoses, valves, pressure gauges, and connecting components such as elbows and tees, manufactured to American National Standard Taper Pipe Thread (NPT) and/or Society of Automotive Engineers (SAE) specifications;
28″×30″ Low Density Polyethylene (LDPE) bags, thermo-sealed along three sides with an integrated resealable pressure strip along the fourth;
Frigidaire refrigerator/freezer appliance were used for standard food preservation, with the freezer chamber temperature set to its lowest temperature setting;
Industrial, thermostatically controlled, forced-air heating units delivering heat to the room hosting the test assembly;
24″×24″×1.9″ reference sample of Insulfoam R-Tech Type-IV 25 psi expanded polystyrene (EPS) foam board;
Graphtec GL220 Midi LOGGER data logger, equipped with 10 analog input terminals, USB/internal memory storage, and a measurement accuracy of ±0.1% of the original reading;
K-type thermocouples for registering temperature data, each with a measurement accuracy of ±0.5% of reading +1.0° C.; and
FluxTeq R-value Measurement System equipped with two PHFS-09e heat flux sensors.

In the interest of brevity, equipment model information and properties not relevant to the final selection of equipment are omitted from discussion.

Procedurally, the earliest tests began with the installation of a flanged port within the surface of the polyethylene bag to provide a connection port between the closed bag chamber and the vacuum pump. Once the flanged port was installed, a sample of core insulation to be tested was placed into the bag and sealed. Separately, the reference sample of EPS insulation was placed in direct contact with and centered along the top-facing insulated surface of the freezer compartment. The bagged insulation sample to be tested was then placed in contact with and centered along the top-facing surface of the reference sample of EPS insulation. Once the combined insulation system was positioned, the vacuum pump was connected to the flanged bag using the associated vacuum pump accessory components. Included as an accessory component was a battery-operated YellowJacket pressure gauge for real-time monitoring of pressures within the closed system.

Once configured, the pump would be activated, and the closed bag chamber would be evacuated to the extent possible. The Graphtec data logger recorded and stored temperature data registered by the thermocouples in one-minute increments. Pressure values were recorded at regular intervals by observing the pressure gauge reading. Pressure data was later analyzed alongside the temperature distribution data.

This configuration and procedural methodology were used over a period of several months to conduct a variety of preliminary tests. Such tests were designed to explore and identify assets and deficits of the system, ultimately to develop a final system capable of producing viable active vacuum insulation panels. The following discussion covers the key conclusions generated during this experimentation period and system alterations that resulted.

### HVAC Vacuum Pump

The YellowJacket SuperEvac 2-stage rotary vane vacuum pump is typically used in Heating, Ventilation, and Air Conditioning (HVAC) applications to prime refrigeration and air conditioning appliances during their installation process. Accordingly, the pump is manufactured to include threaded flare fittings which are standard within the HVAC industry. The pump can evacuate up to 8 cubic feet per minute (CFM) and to pressures on the scale of 10¹ mTorr. Additionally, the rotary vane design enables the pump to maintain an air-tight, closed environment, even while the pump is not in operation.

Testing with the YellowJacket vacuum pump revealed that the rate of evacuation would decrease as pressures within test assemblies approached the scale of 10¹ mTorr. Oftentimes, evacuation would drop to an imperceptibly slow rate as pressures entered the scale of 10² mTorr, even for reasonably airtight assemblies. In testing early active VIP assemblies, system pressures below the scale of 10² mTorr were unable to be achieved. Additionally, achieving system pressures on the scale of 10² mTorr would require multiple days of continuous operation by the vacuum pump.

Because it was desirable for pressures on the scale of 10⁰ mTorr to be achieved and reached quickly during testing, additional investigation into alternative pumps was conducted. This led to the identification of the vacuum pump described in Section 2.2.1.

### Threaded Accessory Components

Threaded flare fittings tapered to a 45° angle, as specified by the SAE, are typically used in refrigeration and air conditioner applications, especially those involving evacuation processes. Non-flared threaded fittings, referred to as American National Standard Taper Pipe Thread (NPT) fittings, are also found in these applications. To be compatible for connection with the YellowJacket vacuum pump, accessory components manufactured with NPT and/or SAE flare fittings were selected for use in the pump assembly.

Multiple tests were conducted to investigate the airtightness of each NPT/SAE flare accessory component used in the pump assembly. For such tests, threaded components would be added to the pump assembly one at a time, and the internal pressure of the closed system would be monitored during a period of evacuation. Once a threaded component was installed, the pump assembly would be evacuated to a common pressure setpoint on the scale of 10¹ mTorr. Once the setpoint was reached, the pump would be turned off, and the pressure within the pump assembly would be monitored to assess the rate of re-pressurization.

Results indicated that while the components themselves could support evacuation to pressures on the scale of 10¹ mTorr while the pump was in operation, they were not capable of maintaining the pressures if the pump were not operational. Once the pump was shut off, the closed system would repressurize and equalize to atmospheric at rates on the scale of 10² mTorr/second at its lowest. Some fittings repressurized at rates exceeding 10³ mTorr per second.

A typical strategy to mitigate air leakage through SAE/NPT flare fittings is to wrap threads with a non-adhesive tape made from Teflon, commonly referred to as “plumber's tape.” The tape is somewhat compressible between threads and serves to occupy open passages within threads through which air would otherwise be able to escape. Additional air-tightness tests were performed on the accessory components with threads wrapped in Teflon tape. The addition of Teflon tape allowed the closed system comprising all accessory components to achieve pressures on the scale of 10¹ mTorr. Once the pump was shut off at the conclusion of each fitting test, the rate of re-pressurization was recorded to be on scales as low as 10¹ mTorr per second when Teflon tape was applied. At this rate, the system would equalize to atmospheric pressures within four hours.

Though strategies exist to mitigate the air leakage rate associated with SAE/NPT flare fittings, the rapid rate of re-pressurization upon pump shut-off significant enough logistical challenges to warrant additional investigation into alternative fitting types. Where the use of SAE/NPT fittings could not be avoided, Teflon tape was applied to SAE/NPT threads.

### Flanged Ports

Three flanged ports were available at the onset of research activities. The Airtech Vac Valve 401 (VV401) machined aluminum flanged port, Airtech Vac Valve 401C (VV401C) cast aluminum flanged port, and an Airtech Vac Valve Premium Multi-Valve 407 (VVMV407) stainless steel flanged port. All ports are composed of three discrete components including a base plate, a connecting top plate with port fitting, and an intermediary silicon gasket. Installation of each port into panel assemblies includes: 1) cutting and removing a 25 mm diameter circular section of the barrier material; 2) placing the base plate on the underside/inside face of the barrier material underneath the cut section; 3) placing the gasketed top plate on the topside/exterior face of the barrier material, positioned and centered over the base plate and; 4) locking the plates together through the barrier material to form an airtight seal against the barrier material.

Material differences notwithstanding, the functional differences between the port types are the mechanisms used to connect the bottom and top plates to each other, and the fitting type used to connect the port to the pump assembly. The VV401 and VV401C ports both employ a mechanical twist-lock connection to fasten the base and top plates together against the barrier material. Both ports are also manufactured with a ¼″ male NPT fitting to be connected to the pump assembly. By contrast, the VVMV407 port employs a screw-down connection to fasten the base and top plates together, and a ¼″ ISO-B “Hansen” style quick-disconnect fitting to be connected to the pump assembly. All ports are designed for use in vacuum assemblies.

Each flanged port was tested in two different evacuated environments to determine its ability to attain vacuum pressures. For the first series of tests, ports were installed within the metallized lid of a canning jar to be sealed and evacuated. For the second series of tests, ports were installed and sealed within a bag composed of a barrier laminate used in VIP applications. Each environment was evacuated for a period of 15 minutes, or until internal pressures reached those on the scale of 10¹ mTorr, whichever occurred earlier. Results from these tests indicated that both the VV401 and VVMV407 ports were capable of reliably attaining pressures on the scale of 10⁰ mTorr within the testing period, while the VV401C only reliably achieved pressures on the scale of 10¹ mTorr.

Though VVMV407 port performed well during these tests, anecdotal evidence from other tests involving the VVMV407 port indicated that unintentional jostling or any lateral disruptions to the port caused re-pressurization spikes which often required hours of further evacuation to return to comparable pressures. For this reason, the VVMV407 port was not used in further tests, and the VV401 machined aluminum port was selected instead.

### Stable Temperature Differential

Early test assemblies employed a standard residential refrigerator/freezer appliance situated indoors within a thermostatically controlled room. The insulation system to be tested was on top of the freezer compartment, separated from the cool freezer environment by the insulated appliance wall. Except for the bottom surface of the reference insulation (in contact with the freezer wall), and the surfaces of the active VIP prototype and reference insulation in contact only with each other, all other surfaces of the insulation system were exposed to the ambient indoor environment of the testing room.

When analyzing the resulting temperature distribution across the insulation system, it was noticed that the temperature within the freezer regularly cycled between a high and low setpoint. Similarly, the industrial heaters that provided heat to the room also regularly cycled between a high and low temperature setpoint. This resulted in a highly inconsistent temperature differential across the insulation system, and consequently, a dynamic and inconsistent heat transfer lag through the insulation system. Resulting thermal conductivity values calculated for each insulation component were therefore widely distributed, making it difficult to accurately assess their thermal performance relative to each other. Given that thermal performance metrics are of primary interest and critical to this research, and thus a high degree of accuracy in thermal performance measurements is desired, additional investigations into more thermally stable heating and cooling appliances were conducted.

Additionally, the exposure of the insulation system to ambient indoor environmental conditions, and to associated convective currents, often resulted in highly variable temperatures registered in between the reference insulation and active VIP prototype. To further isolate the thermal environment in-between the reference insulation and active VIP prototype from the external environment of the room, the edges of the insulation system were taped.

### Polyethylene Barrier Material

Barrier laminates designed for use in passive VIP applications often optimize MVTR and OTR properties to extend the lifespan of the VIP. Because gas and moisture transmission through the barrier membrane can be minimized through regular evacuation of the system, as is the case in active VIP assemblies, an early research goal subjected to experimentation was to determine whether a more readily available, inexpensive, and easily manipulatable barrier material could support vacuum pressures on the scale of 10⁰ mTorr.

The earliest panel assemblies employed a 710 mm×760 mm×0.2 mm LDPE resealable bag material to encase core insulation samples. The bagging material was premanufactured with three thermo-sealed edges, and a resealable pressure strip along the fourth edge. Both MVTR and OTR specifications for this material are unknown, and the product is explicitly marketed as a non-airtight bag. It is thus presumed that the polyethylene bag material is relatively permeable to air and moisture transmission, and likely comparable to other LDPE barriers which offer MVTR and OTR properties in the range of 23 [gr/(m²·24 hrs)] and 194 [cc/(m²·24 hrs)], respectively [36].

Tests of active VIP prototypes using the polyethylene barrier material were unable to achieve pressures below the scale of 10² mTorr. Several attempts were made to apply low-volatility vacuum grease along the inside edge of all seams, which resulted in an improved ability of the system assembly to achieve lower pressures. Unfortunately, the resealable pressure strip and edge seams were highly vulnerable to air infiltration if manipulated or deflected, even when ample vacuum grease had been applied along all seams. The result was the rapid re-pressurization of the system assembly, which often required extensive evacuation to depressurize again.

In the interest of developing panel assemblies capable of reliably achieving and maintaining pressures on the scale of 10⁰ mTorr, additional investigation was conducted into alternative barrier materials. Additionally, the observed positive impact of low-volatility vacuum grease on the evacuation process led researchers to adopt the practice of applying vacuum grease to all junction points throughout the active VIP assembly.

### Barrier Sealing

All prototypes using metallized barrier laminates mentioned in this report employed a direct heat hand sealer in the manufacture of bag enclosures. This type of heat sealer created seals about 150 mm in length and 15 mm in width, had a temperature range 140° C.-200° C., and was designed for thermoplastics. This portable direct heat sealer was used in the manufacture of all prototype envelopes except for tests using off-the-shelf VIPs without ports installed.

An impulse sealer, which was recommended by a prominent barrier laminate manufacturer, was purchased and tested on several prototype samples. Through testing, a 100-150 mm recurring inhomogeneity in the resulting seals was noticed. Separate seal tests were conducted to determine whether the inhomogeneity compromised the integrity of the seal to achieve and maintain a vacuum, and the results were at first inconclusive. In response, a redundant perimeter seal was applied to the prototype envelopes using the portable direct heat sealer to ensure that the envelopes could attain and maintain desired vacuum pressures. For the purposes of this thesis, any influence of heat seals created by the impulse heat sealer can be ignored.

### Heat Flux Measurements

At the onset of research, heat flux sensors were installed between the reference and test insulation samples to directly monitor and collect heat flux data. This was done to support the calculation of test sample thermal conductivities from temperature and heat flux data alone. For this effort, a FluxTeq R-value Measurement System equipped with two PHFS-09e heat flux sensors were employed. Heat flux data was collected in tandem with temperature data collected from the thermocouple arrangement described in previous sections.

Data from these sensors was consistently collected and analyzed during earlier tests involving the system assembly. Though the heat flux equipment was properly calibrated, it was discovered that thermal conductivity calculations based on data collected by the heat flux data logger produced physically unlikely results. Troubleshooting efforts were conducted but were unsuccessful. The lack of usable data led researchers to abandon the use of heat flux sensors in favor of the thermocouple arrangement only. Instead of using heat flux information to calculate thermal conductivity, researchers instead opted to use the ratio of temperature differentials measured across the reference and test insulation samples to determine thermal conductivity measurements.

### Elimination of Residual Moisture

Once active VIP assemblies began to be reliably produced, it was of interest to researchers to assess the capacity of the pump assembly to evacuate residual moisture from panel assemblies. To prepare for this experimentation, researchers unsealed a passive VIP, removed the fiberglass core insulation, soaked the fiberglass in approximately 1.8 liters of distilled water, and weighed it to record a baseline weight. The soaked sample was placed back within the barrier laminate enclosure it originated from, a flanged port was installed within the barrier membrane, and the sample was resealed. The soaked active VIP sample was then connected to the pump assembly, placed within the system assembly, and evacuation was initiated. To ensure that the vacuum pump would not be damaged during the evacuation of the volume of water, the gas ballast was engaged until it became evident that the water had been fully removed from the panel.

During the first 28 hours of evacuation, the test sample was unable to be evacuated to pressures below the scale of 10³ mTorr. The thermal conductivity of the soaked-fiberglass test sample was also shown to be higher than the reference insulation, indicated by the smaller temperature differential across the sample. Additionally, the CH1 thermocouple placed facing the cooler environment paradoxically registered the warmest temperatures experienced by the insulation system during this time. Upon physical inspection, the test insulation sample was found to be frozen within a radius of several inches from the flanged port, and the QF25 elbow component connecting the flange to the pump assembly had become almost completely blocked by ice. This was likely due to the evaporative cooling effect of the evacuation process, which increased the boiling point of liquid water to temperatures below 0° C.

Once the ice blockage had been removed, the system was reassembled, and evacuation resumed. After an additional 36 hours of evacuation, the active VIP assembly experienced a sudden increase in the temperature distribution across the sample accompanied by an acute drop in internal pressure. This was followed shortly thereafter by a shallow but continuous drop in both the internal pressure and thermal conductivity of the test sample. The internal pressure eventually stabilized to an average of 3.62 mTorr, at which point the active VIP assembly registered an average per inch R-values of 43.9° F.·ft²·hr/(BTU·inch). This per inch R-value is comparable to both active VIPs tested previously and subsequently. This suggests that the acute increase in thermal performance and decrease in pressure was due to the last volumes of water being evacuated successfully from the panel assembly. Upon the conclusion of testing, the fiberglass core material was weighed again, and had returned to within 10 g of its initial, pre-soaked mass. Virtually all water had evaporated from the panel assembly.

These results gave the author confidence that the active VIP assembly was highly capable of evacuating residual moisture from panel assemblies. With this finding, the author decided to forgo baking procedures of core materials prior to their installation in panel assemblies, which would have served to eliminate residual moisture, and instead opted to rely on the gas-ballast feature of the pump assembly for removing moisture.

### Compression Inhomogeneities

In early experiments with active VIP assemblies, it was observed that panels would cup or bow during the initial stages of evacuation and would be difficult to press flat for testing. To combat this, various weights were experimented with to assist with the homogenous, flat compression of panels during evacuation. In later iterations, including for use in the tests described in the main body of this thesis, the weights selected were of concrete, and were of the approximate dimensions 200 mm×200 mm×25 mm (W×L×H). Four of these weights were placed so their mass was distributed as evenly as possible over the surface of the test sample. Weights were also placed to give the CH5 thermocouple and flanged port ample room and limit any thermophysical interference. Cardboard mats were placed between the weights and the surface of the test panels to protect the barrier laminate. The weights were shown to be highly effective in compressing the test samples homogenously during evacuation, and so were incorporated into testing methodology.

### Expanded Polystyrene Active VIP Assembly

Among the first research activities undertaken was testing a sample of closed-cell EPS foam board as the core insulation material in the active VIP assembly. The goal of this activity was to observe the thermal performance of a closed-cell system in evacuated environments and determine whether it would be a viable choice for further active VIP assembly investigations.

The appliance conditions used for this test were like those described in Section 3.4.1 for the first fiberglass active VIP prototype. The test insulation sample used comprised a sample of Insulfoam R-Tech Type-IV 25 psi EPS foam board 48.4 mm in thickness and cut to dimensions 610 mm×610 mm. This sample core was placed into the same barrier laminate material of unknown properties as was used in the tests described in Sections 3.3.1 and 3.4.1. The panel assembly was then prepared for testing per the same methodology described in Section 2.2.3.

Observation of the system during the early stages of evacuation showed that the system struggled to evacuate sections of the panel that were further from the flanged port. Disassembling the panel assembly revealed that the flanged port had become embedded into the foam board, which stymied evacuation throughout the entire panel. To combat this, a layer of 1.2 mm×1.2 mm polyester mesh was used to wrap the EPS core. The hypothesis was that continuous air channels would be created by placing a channeled mesh over the entire surface of the EPS core, and thus would allow evacuation to proceed more effectively.

Once the mesh was installed and the system re-assembled, evacuation began again. Though the mesh created a considerable improvement in full-panel evacuation, it took upwards of five days of continuous evacuation to achieve internal pressures on the scale of 10² mTorr. Several times during the testing period, the vacuum pump would be temporarily shut off for upwards of 24 hours at a time, but temperature and pressure data were continuously recorded. At the conclusion of testing, the post-evacuation thickness of the EPS core had compressed from ˜48.4 mm to ˜35 mm. The surface of the EPS also changed from a flat and smooth appearance to in-homogenous and bumpy.

Analysis of the resulting data revealed the thermal conductivity of the EPS was indeed correlated to internal pressure. When the pump was engaged and the system actively evacuated, internal pressures on the scale of 10¹ mTorr were achieved along with associated per inch R-values of 6.1° F.·ft²·hr/(BTU·inch), or ˜25% higher than 4.4° F.·ft²·hr/(BTU·inch) of the reference insulation. Furthermore, once the pump was turned off and the internal pressures surpassed the scale of 10² mTorr, the insulation value of the test sample would drop to its lowest value, 4.4° F.·ft²·hr/(BTU·inch).

Interesting to note is that even after the test sample compressed to 25% of its original thickness, its per inch R-value remained the same even when measured at atmospheric pressures. This implies that the solid thermal conductivity of the matrix is not affected by increasing the density of EPS. The results also indicate that thermal conductivity of EPS at low pressures decreases. However, because evacuation of EPS test samples required extensive lengths of continuous evacuation to reach desired internal pressures for testing, and because the thermal performance improved only modestly at low pressures, further testing activities into EPS-based panels were ultimately abandoned in favor of fiberglass-based panels.

### REFERENCES

The following references are hereby incorporated by reference herein in their respective entireties:
[1] R. Baetens et al., “Vacuum insulation panels for building applications: a review and beyond,” Energy Build., vol. 42, pp. 147-172, 2010, doi: 10.1016/j.enbuild.2009.09.005.
[2] V. Ting et al., “Critical analysis of in situ performance of glass fiber core VIPs in extreme cold climate,” Front. Energy Res., vol. 7, no. 45, pp. 1-7, 2019, doi: 10.3389/fenrg.2019.00045.
[3] S. Mao, A. Kan, Z. Huang, and W. Zhu, “Prediction of thermal performance of vacuum insulation panels (VIPs) with micro-fiber core materials,” Mater. Today Commun., vol. 22, 2020, doi: 10.1016/j.mtcomm.2019.100786.
[4] B. Chang, L. Zhong, and A. Mufit, “Low cost composites for vacuum insulation core material,” Vacuum, vol. 131, pp. 120-126, 2016, doi: 10.1016/j.vacuum.2016.05.027.
[5] C. M. Wong and M. L. Hung, “Polystyrene foams as core materials used in vacuum insulation panel,” J. Cell. Plast., vol. 44, pp. 239-259, 2008, doi: 10.1177/0021955X08090420.
[6] H. Simmler et al., “Vacuum insulation panels-study on VIP-components and panels for service life prediction of VIP in building applications (subtask A),” IEA/ECBCS Annex 39, Switzerland, 2005. Accessed: Oct. 18, 2022. [Online]. Available: https://www.iea-ebc.org/Data/publications/EBC_Annex_39_Report_Subtask-A.pdf
[7] Á. Lakatos, I. Vsarnovic, and A. Csik, “Systematic analysis of micro-fiber thermal insulations from a thermal properties point of view,” Appl. Sci., no. 11, 2021, doi: 10.3390/app11114943.
[8] S. Resalati, T. Okoroafor, P. Henshall, N. Simoes, M. Gonçalves, and M. Alam, “Comparative life cycle assessment of different vacuum insulation panel core materials using a cradle to gate approach,” Build. Environ., vol. 188, 2021, doi: 10.1016/j.buildenv.2020.107501.
[9] S. E. Kalnæs and B. P. Jelle, “Vacuum insulation panel products: a state-of-the-art review and future research pathways,” Appl. Energy, vol. 116, pp. 355-375, 2014, doi: 10.1016/j.apenergy.2013.11.032.
[10] Z. Chen et al., “Preparation and characterization of vacuum insulation panels with super-stratified glass fiber core material,” Energy, vol. 93, pp. 945-954, 2015, doi: 10.1016/j.energy.2015.08.105.
[11] M. Alam, “Development of vacuum insulating panels with low cost core material,” Ph.D. dissertation, Dept. Mech. Aerosp. Civ. Eng., Brunel University London, London, England, 2015.
[12] U. Heinemann et al., “Vacuum insulation panel properties and building applications,” IEA/ECBCS Annex 39, Switzerland, 2010. Accessed: Oct. 18, 2022. [Online]. Available: https://www.iea-ebc.org/Data/publications/EBC_Annex_39_PSR.pdf
[13] Y. Carmi, “The effect of thermal bridge in VIPs,” Avery Dennison Hanita, 2019. Accessed: Oct. 18, 2022. [Online]. Available: https://hanita.averydennison.com/content/dam/averydennison/hanita/en/docs/home/customer-tools/technical-docs/td-the-effect-of-thermal-bridge-in-vips.pdf
[14] S. S. Alotaibi and S. Riffat, “Vacuum insulated panels for sustainable buildings: a review of research and applications,” Int. J. Energy Res., vol. 38, pp. 1-19, 2014, doi: 10.1002/er.
[15] E. Shufer, “A comparison of the barrier properties of VIP laminates-new PST technology,” Avery Dennison Hanita, 2019. Accessed: Oct. 18, 2022. [Online]. Available: https://hanita.averydennison.com/content/dam/averydennison/hanita/en/docs/home/customer-tools/technical-docs/td-comparison-of-barrier-of-vip-laminates-new-pst-technology.pdf
[16] M. Tenpierik and H. Cauberg, “Analytical models for calculating thermal Bridge effects caused by thin high narrier envelopes around VIPs,” J. Build. Phys., vol. 30, no. 3, 2007, doi: 10.1177/17442591070731.
[17] T. V Moore, “Evaluating the thermal resistance of a vacuum insulation panel wall assembly containing thermal bridges using industry standard calculation methods and numerical simulation techniques,” M.A. Sc. thesis, Dept. Mech. Eng., Carleton University, Ottawa, Canada, 2017.
[18] J. Kwon, C. H. Jang, H. Jung, and T. Song, “Effective thermal conductivity of various filling materials for vacuum insulation panels,” Int. J. Heat Mass Transf., vol. 52, pp. 5525-5532, 2009, doi: 10.1016/j.ijheatmasstransfer.2009.06.029.
[19] J. Zach, J. Peterková, Z. Dufek, and T. Sekavčnik, “Development of vacuum insulating panels (VIP) with non-traditional core materials,” Energy Build., vol. 199, pp. 12-19, 2015, doi: 10.1016/j.enbuild.2019.06.026.
[20] X. Di, Y. Gao, C. Bao, and Y. Hu, “Optimization of glass fiber based core materials for vacuum insulation panels with laminated aluminum foils as envelopes,” Vacuum, vol. 97, pp. 55-59, 2013, doi: 10.1016/j.vacuum.2013.04.005.
[21] “Vacuum insulation panels (VIPs)—a global market overview,” Research and Markets. https://www.researchandmarkets.com/reports/5238766/vacuum-insulation-panels-vips-a-global-market (accessed Oct. 18, 2022).
[22] T. Xu et al., “Correlation between the thermo-physical properties and core material structure of vacuum insulation panel: role of fiber types,” Fibers Polym., vol. 19, no. 5, pp. 1032-1038, 2018, doi: 10.1007/s12221-018-7949-x.
[23] S. Verma and H. Singh, “Vacuum insulation in cold chain equipment: A review,” in 2nd Int. Conf. Sustain. Energy Resour. Use Food Chains, Paphos, Cyprus, 2019, vol. 161, pp. 232-241. doi: 10.1016/j.egypro.2019.02.086.
[24] P. Ashokan, “A comparative study for cold chain packaging options,” M.S. thesis, Dept. Packag. Sci., Rochester Institute of Technology, Rochester, NY, USA, 2011.
[25] D. Ürge-vorsatz, L. F. Cabeza, S. Serrano, and C. Barreneche, “Heating and cooling energy trends and drivers in buildings,” Renew. Sustain. Energy Rev., vol. 41, pp. 85-98, 2015, doi: 10.1016/j.rser.2014.08.039.
[26] B. P. Jelle, “Traditional, state-of-the-art and future thermal building insulation materials and solutions-properties, requirements and possibilities,” Energy Build., vol. 43, pp. 2549-2563, 2011, doi: 10.1016/j.enbuild.2011.05.015.
[27] M. Alam, H. Singh, and M. C. Limbachiya, “Vacuum insulation panels (VIPs) for building construction industry—a review of the contemporary developments and future directions,” Appl. Energy, vol. 88, no. 11, pp. 3592-3602, 2011, doi: 10.1016/j.apenergy.2011.04.040.
[28] B. S. K. Chang, “Vacuum insulation panel core materials and modelling the thermal conductivity of granular materials,” M.S. thesis, Dept. Mater. Sci. and Eng., Iowa State Univ., Ames, 2015.
[29] A. Muir and M. Overend, “A parametric feasibility study on active vacuum insulation panels for buildings,” in 9th Int. Vac. Insul. Symp., London, England, 2009. [Online]. Available: http://www.ivisnet.org/
[30] A. H. A. Dehwah and M. Krarti, “Impact of switchable roof insulation on energy performance of US residential buildings,” Build. Environ., vol. 177, 2020, doi: 10.1016/j.buildenv.2020.106882.
[31] A. Berge, C. Hagentoft, P. Wahlgren, and B. Adl-zarrabi, “Effect from a variable U-value in adaptive building components with controlled internal air pressure,” in 6th Int. Build. Phys. Conf., 2015, vol. 78, pp. 376-381. doi: 10.1016/j.egypro.2015.11.677.
[32] H. Cui and M. Overend, “A review of heat transfer characteristics of switchable insulation technologies for thermally adaptive building envelopes,” Energy Build., vol. 199, pp. 427-444, 2019, doi: 10.1016/j.enbuild.2019.07.004.
[33] K. Biswas, P. Cao, and T. Saito, “Self-healing barrier films for vacuum insulation panels,” U.S. patent application Ser. No. 16/746,149, Jul. 23, 2020.
[34] L. E. Pierce, “Vacuum soundproofing/insulating panels with vacuum pump connector assembly and method and system for using same to provide adjustable insulative efficiency to a building envelope,” U.S. patent application Ser. No. 16/980,297, Jan. 7, 2019.
[35] D. Consigny, “Twin-wall panel,” FR Patent 2628179A1, Mar. 2, 1988.
[36] “Physical properties table” ThermoScientific. https://static.thermoscientific.com/images/D20826˜.pdf (accessed Oct. 18, 2022).

Although the foregoing invention has been described in some detail by way of illustration and example for purposes of clarity of understanding, certain changes and modifications may be practiced within the scope of the appended claims.

What is claimed is:

1. An insulating element, comprising:
a shell having an interior and an exterior; and
a core material positioned within the interior of the shell, wherein the core material is configured to inhibit collapse of the shell when the shell is subject to a pressure differential between the interior and the exterior,
wherein the shell defines an opening configured to provide communication with a vacuum source.

2. The insulating element of claim 1, further comprising a port coupled to the shell, wherein the port is in communication with the opening of the shell, wherein the port is configured to fluidly couple to the vacuum source.

3. The insulating element of claim 2, wherein the port is integrally formed with the shell.

4. The insulating element of claim 2, wherein the port is coupled to the shell by a compression seal.

5. The insulating element of claim 1, wherein the core material comprises fiberglass, fumed silica, open-cell foam, aerogel, or nanogel.

6. The insulating element of claim 1, wherein the core material comprises fiberglass.

7. The insulating element of claim 1, wherein the core material is configured to compress by no more than 50% when subject to a total vacuum within the shell.

8. The insulating element of claim 1, wherein the shell comprises a laminate having a sealing layer, a protective material layer, and a metallized or foil layer.

9. The insulating element of claim 8, wherein the laminate is heat-sealed along at least one edge to form the shell.

10. The insulating element of claim 1, further comprising a support structure that is configured to inhibit deformation of the insulation element due to the pressure differential between the interior and the exterior.

11. The insulating element of claim 1, wherein the core material is configured to inhibit collapse of the shell with a pressure differential between the interior and the exterior under 100 mTorr.

12. The insulating element of claim 1, wherein the core material is configured to inhibit collapse of the shell with a pressure differential between the interior and the exterior under 10 mTorr.

13. The insulating element of claim 1, further comprising an opacifier that is configured to inhibit radiative heat transfer.

14. The insulating element of claim 1, wherein the shell has a length of at least 500 mm and a width of at least 500 mm.

15. The insulating element of claim 1, wherein the vacuum source includes one of a vacuum pump and a vacuum tank with a sorbent.

16. A system comprising:
an insulating element comprising:
a shell having an interior and an exterior;
a core material positioned within the interior of the shell, wherein the core material is configured to inhibit collapse of the shell when the shell is subject to a pressure differential between the interior and the exterior,
wherein the shell defines an opening; and
a vacuum source in communication with the opening of the shell.

17. The system of claim 16, further comprising a valve that is configured to fluidly decouple the vacuum source from the insulating element.

18. The system of claim 17, wherein the valve is one of a check valve and a manually operated valve.

19. The system of claim 16, wherein the vacuum source is configured to form a vacuum under 100 mTorr.

20. The system of claim 16, wherein the vacuum source is a 2-stage vacuum pump.
